(19) United States
(12) Patent Application Publication
(10) Pub. No.: US 2025/0269803 A1
(43) Pub. Date: Aug. 28, 2025

(54) TRUCK BED EXTENSION SYSTEM

(71) Applicant: Kevin P. Johnson, Waukee, IA (US)

(72) Inventor: Kevin P. Johnson, Waukee, IA (US)

(21) Appl. No.: 19/058,319

(22) Filed: Feb. 20, 2025

Related U.S. Application Data
(60) Provisional application No. 63/557,017, filed on Feb. 23, 2024.

(51) Int. Cl. B60R 9/06

(52) U.S. Cl. CPC B60R 9/06

(57) ABSTRACT

In one or more arrangements, a truck bed extension system is presented for use in connection with a truck. In one or more arrangements, the truck bed extension system includes a plurality of extension members and a plurality of connection members. In one or more arrangements, the plurality of extension members include a core member and telescoping members configured to extend outward from the core member. In one or more arrangements, the plurality of connection members are configured to connect the plurality of extension members to other extension members. In one or more arrangements, the plurality of extension members are configured to engage a portion of the truck bed. In one or more arrangements, the truck bed extension system is configured to extend outward from the truck bed in order to allow the truck to haul materials or objects that are larger than the truck bed.

### CROSS-REFERENCE TO RELATED APPLICATIONS

This application claims prior to U.S. Provisional Application No. 63/557,017 entitled TRUCK BED EXTENSION SYSTEM and filed on Feb. 23, 2024, the entirety of which is hereby incorporated by reference herein, including any figures, tables, drawings, and other information.

### FIELD OF THE DISCLOSURE

This disclosure relates to a truck bed accessory. More specifically, this disclosure relates to a system for effectively extending the working size of a truck bed.

### OVERVIEW OF THE DISCLOSURE

Pickup truck beds can vary in size and shape. The width of pickup truck beds fluctuates from model to model and even from year to year of similar models. The length of pickup truck beds, on the other hand, can vary in length, with lengths such as five foot two inches (5′2″) (considered a short bed), six foot five inches (6′5″) (considered a standard bed) or eight foot (8′) (considered a long bed). Trucks with long beds are able to handle material that is longer than short bed or standard bed trucks.

Because the length and width of truck beds vary, drivers with short bed trucks, or drivers with trucks having narrower beds, may need a way to effectively extend the working size of the truck bed in order to haul larger materials or objects. Various truck bed systems exist that extend the working size of the truck bed, however these systems are either fixed systems that are not adjustable or able to be taken on and off when desired. Other systems are difficult to install quickly and efficiently and require numerous steps to make sure the system is secure. Other systems also cannot be used with standard truck bed covers-rather other systems require covers to be custom made or modified to allow for use of such other systems.

Therefore, for all the reasons stated above, and the reasons stated below, there is a need in the art for an improved truck bed extension system. Thus, it is a primary objective of the disclosure to provide a truck bed extension system that improves upon the state of the art.

Another objective of the disclosure is to provide a truck bed extension system which extends the effective working size of the truck bed.

Yet another objective of the disclosure is to provide a truck bed extension system which is safe to install.

Another objective of the disclosure is to provide a truck bed extension system which is quick to install.

Yet another objective of the disclosure is to provide a truck bed extension system which is easy to install.

Another objective of the disclosure is to provide a truck bed extension system which is safe to use while driving.

Yet another objective of the disclosure is to provide a truck bed extension system which is able to comply with road width travel restrictions.

Another objective of the disclosure is to provide a truck bed extension system which is relatively easy to build.

Yet another objective of the disclosure is to provide a truck bed extension system which can be built relatively quickly and efficiently.

Another objective of the disclosure is to provide a truck bed extension system which is easy to operate.

Yet another objective of the disclosure is to provide a truck bed extension system which is relatively cost friendly to manufacture.

Another objective of the disclosure is to provide a truck bed extension system which is relatively easy to transport.

Yet another objective of the disclosure is to provide a truck bed extension system which is aesthetically appealing.

Another objective of the disclosure is to provide a truck bed extension system which is robust.

Yet another objective of the disclosure is to provide a truck bed extension system which is not easily susceptible to wear and tear.

Another objective of the disclosure is to provide a truck bed extension system which has a long useful life.

Yet another objective of the disclosure is to provide a truck bed extension system which is efficient to use and operate.

Another objective of this disclosure is to provide a truck bed extension system which allows for temporary use and can be quickly and easily installed and removed without defacing the truck bed.

Yet another objective of the disclosure is to provide a truck bed extension system which can be used short term and can be quickly and easily be installed and removed without defacing the truck bed.

Another objective of this disclosure is to provide a truck bed extension system which allows for use with existing or new truck bed covers that require no removal or modifications.

Yet another objective of this disclosure is to provide a truck bed extension system which provides two cross bars for securing the load in various different configurations.

Another objective of this disclosure is to provide a truck bed extension system which can fit in the truck bed when not in use.

These and other objects, features, or advantages of the disclosure will become apparent from the specification, figures, and claims.

### SUMMARY OF THE DISCLOSURE

In one or more arrangements, a truck bed extension system is presented for use in connection with a truck. In one or more arrangements, the truck bed extension system includes a plurality of extension members and a plurality of connection members. In one or more arrangements, the plurality of extension members include a core member and telescoping members configured to extend outward from the core member. In one or more arrangements, the plurality of connection members are configured to connect the plurality of extension members at opposing ends of the plurality of connection members. In one or more arrangements, the plurality of extension members are configured to engage a portion of the truck bed. In one or more arrangements, the truck bed extension system is configured to extend outward from the truck bed in order to allow the truck to haul materials or objects that are larger than the truck bed.

### BRIEF DESCRIPTION OF THE FIGURES

FIG. 1 is a top view of a truck bed extension system; the view showing the system having extension members having core members and telescoping members; the view also showing the system having connection members operably connected to the core members of the extension members; the view also showing the system having a first set of straps and a second set of straps.

FIG. 2 is a view of a truck bed extension system having an extension member with a core member operably connected to a connection member via a U-bolt.

FIG. 3 is a view of a truck bed extension system having an extension member with a core member operably connected to a connection member via a U-bolt; the view showing the system inserted into a truck bed.

FIG. 4 is a view of a truck bed extension system having an extension member with a core member operably connected to a connection member via a U-bolt.

FIG. 5 is a view of a truck bed extension system having an extension member with a core member operably connected to a connection member via a U-bolt.

FIG. 6 is a view of a truck bed extension system having an extension member operably connected to multiple connection members.

FIG. 7 is a view of a truck bed extension system having an extension member having a core member and a telescoping member; the view also showing the telescoping member securely engaged with the core member via a fastener; the view showing the telescoping member in a semi-retracted position.

FIG. 8 is a view of a truck bed extension system having an extension member having a core member and a telescoping member; the view also showing the telescoping member securely engaged with the core member via a fastener; the view showing the telescoping member in an semi-extended position.

FIG. 9 is a view of a truck bed extension system having an extension member having a core member and a telescoping member; the view also showing the telescoping member securely engaged with the core member via a fastener.

FIG. 10 is a top perspective view of a truck bed extension system which is in the process of being installed; the system having a pair of extension members with core members and telescoping members; the system also having a pair of connection members operably connected to the pair of extension members.

FIG. 11 is a view of a truck bed extension system having connection members and an extension member with a core member.

FIG. 12 is a view of a truck bed extension system installed in a truck bed, the view showing the system having an extension member having a core member and a telescoping member operably connected to the truck bed.

FIG. 13 is a view of a truck bed extension system installed in a truck bed, the view showing the system having an extension member having a telescoping member operably connected to the truck bed.

FIG. 14 is a view of a truck bed extension system, the view showing the system having an extension member having a core member and a telescoping member.

FIG. 15 is a view of a truck bed extension system installed in a truck bed, the view showing the system having an extension member having a core member and a telescoping member operably connected to the truck bed.

FIG. 16 is a view of a truck bed extension system installed in a truck bed, the view showing the system having an extension member having a core member and a telescoping member operably connected to the truck bed.

FIG. 17 is a top perspective view of a truck bed extension system installed in a truck bed;

the system having a pair of extension members with core members and telescoping members operably connected to the truck bed; the system also having a pair of connection members operably connected to the pair of extension members.

FIG. 18 is a view of a truck bed extension system having connection members and an extension member with a core member; the view also showing stabilizer pins extended through the connection members in order to prevent the system from sliding forward relative to the truck bed when in use.

FIG. 19 is a view of a truck bed extension system having stabilizer pins extended through the connection members in order to prevent the system from sliding forward relative to the truck bed when in use.

FIG. 20 is a view of a truck bed extension system having stabilizer pins extended through the connection members in order to prevent the system from sliding forward relative to the truck bed when in use.

FIG. 21 is a view of a truck bed extension system having connection members and an extension member with a core member; the view also showing stabilizer pins extended through the connection members in order to prevent the system from sliding forward relative to the truck bed when in use.

FIG. 22 is a view of a truck bed extension system having a connection member and an extension member with a core member and a telescoping member; the view also showing a strap operably connected to the connection member.

FIG. 23 is a view of a truck bed extension system having connection members and an extension member operably connected to the connection members; the view also showing a first set of straps operably connected to a truck and to the connection members.

FIG. 24 is a view of a first set of straps of a truck bed extension system operably connected to a truck.

FIG. 25 is a view of a first set of straps of a truck bed extension system operably connected to a truck.

FIG. 26 is a view of a truck bed extension system having connection members and an extension member operably connected to the connection members; the view showing a first set of straps operably connected to a truck and to the connection members; the view also showing stabilizer pins extended through the connection members in order to prevent the system from sliding forward relative to the truck bed when in use.

FIG. 27 is a view of a truck bed extension system having connection members and an extension member operably connected to the connection members; the view also showing stabilizer pins extended through the connection members in order to prevent the system from sliding forward relative to the truck bed when in use.

FIG. 28 is a view of a truck bed extension system having connection members and extension members operably connected to the connection members; the view showing a first set of straps operably connected to a truck and to the connection members; the view also showing stabilizer pins extended through the connection members in order to prevent the system from sliding forward relative to the truck bed when in use.

FIG. 29 is a view of a truck bed extension system having connection members and an extension member operably connected to the connection members; the view showing a first set of straps operably connected to a truck and to the connection members; the view also showing stabilizer pins extended through the connection members in order to prevent the system from sliding forward relative to the truck bed when in use.

FIG. 30 is a view of a truck bed extension system having connection members and an extension member operably connected to the connection members; the view showing a first set of straps operably connected to a truck and to the connection members.

FIG. 31 is a view of a truck bed extension system having connection members and an extension member operably connected to the connection members; the view showing a first set of straps operably connected to a truck and to the connection members.

FIG. 32 is a view of a truck bed extension system having connection members and an extension member operably connected to the connection members; the view showing a first set of straps operably connected to a truck and to the connection members; the view also showing the system being used to support a ladder.

FIG. 33 is a view of a truck bed extension system having connection members and extension members operably connected to the connection members; the view showing a first set of straps operably connected to a truck and to the connection members; the view also showing the system being used to support a ladder.

FIG. 34 is a view of a truck bed extension system having connection members and extension members operably connected to the connection members; the view showing a first set of straps operably connected to a truck and to the connection members; the view also showing the system being used to support a ladder.

FIG. 35 is a view of a truck bed extension system having connection members and extension members operably connected to the connection members; the view showing a first set of straps operably connected to a truck and to the connection members; the view also showing the system being used to support two ladders which are secured to the system via a second set of straps.

FIG. 36 is a view of a truck bed extension system having connection members and extension members operably connected to the connection members; the view showing a first set of straps operably connected to a truck and to the connection members; the view also showing the system being used to support two ladders which are secured to the system via a second set of straps.

FIG. 37 is a view of a truck bed extension system having a connection member and extension members operably connected to the connection member; the view also showing the system being used to support a ladder.

FIG. 38 is a view of a connection member of a truck bed extension system; the view showing the connection member having openings.

FIG. 39 is a view of a truck bed extension system having a connection member and extension members operably connected to the connection member; the view also showing the system being used to support a ladder.

FIG. 40 is a view of a truck bed extension system having connection members and extension members operably connected to the connection members; the view also showing the system being used to support lumber.

FIG. 41 is a view of a truck bed extension system having connection members and extension members operably connected to the connection members; the view showing a first set of straps operably connected to a truck and to the connection members; the view also showing the system being used to support lumber.

FIG. 42 is a view of a truck bed extension system having connection members and extension members operably connected to the connection members; the view showing a first set of straps operably connected to a truck and to the connection members; the view showing the system positioned in order to operably extend the width of the truck bed.

FIG. 43 is a view of a truck bed extension system having connection members and extension members operably connected to the connection members; the view showing a first set of straps operably connected to a truck and to the connection members; the view showing the system positioned in order to operably extend the width of the truck bed.

FIG. 44 is a view of a connection member of a truck bed extension system; the view showing the connection member having a core member and a telescoping member with an eye bolt operably connected to the telescoping member.

FIG. 45 is a view of a truck bed extension system having connection members and an extension member operably connected to the connection members; the view showing stabilizer pins extended through the connection members in order to prevent the system from sliding forward relative to the truck bed when in use.

FIG. 46 is a view of a truck bed extension system having connection members and an extension member operably connected to the connection members; the view showing the system positioned in order to operably extend the width of the truck bed.

FIG. 47 is a view of a connection member of a truck bed extension system; the view showing the connection member having a core member and a telescoping member with an eye bolt operably connected to the telescoping member.

FIG. 48 is a view of a connection member of a truck bed extension system; the view showing the connection member having a core member and a telescoping member with a dowel operably connected to the telescoping member.

FIG. 49 is a view of a truck bed extension system having connection members and an extension member operably connected to the connection members; the view showing a first set of straps operably connected to a truck and to the connection members; the view also showing a dowel operably connected to an extension member.

FIG. 50 is a top view of a truck bed extension system; the view showing the system having extension members having core members and telescoping members; the view also showing the system having connection members operably connected to the core members of the extension members; the view also showing the system having a first set of straps and a second set of straps.

FIG. 51 is an exploded view of a truck bed extension system; the view showing the system having an extension member, a connection member, and a bracket configured to connect the extension member to the connection member; the view showing the bracket having sidewalls and fasteners.

FIG. 52 is an exploded view of a truck bed extension system; the view showing the system having an extension member, a connection member, and a bracket configured to connect the extension member to the connection member; the view showing the bracket having sidewalls and fasteners.

FIG. 53 is an exploded view of a truck bed extension system; the view showing the system having an extension member, a connection member, and a bracket configured to connect the extension member to the connection member; the view showing the bracket having sidewalls and fasteners.

FIG. 54 is an exploded view of a truck bed extension system; the view showing the system having an extension member, a connection member, and a bracket configured to connect the extension member to the connection member; the view showing the bracket having sidewalls and fasteners.

FIG. 55 is a perspective view of a bracket positioned on a connection member of a truck bed extension system.

FIG. 56 is a close-up view of a bracket positioned on a connection member of a truck bed extension system; the view showing the bracket having sidewalls with an opening; the view showing the connection member with an opening; the view also showing the opening of the sidewalls of the bracket aligned with the opening of the connection member.

FIG. 57 is a perspective view of a bracket positioned on a connection member of a truck bed extension system; the view also showing the bracket connected to connection member via a fastener.

FIG. 58 is a perspective view of a bracket operably connected to both an extension member and a connection member of a truck bed extension system; the view showing the bracket operably connected to the extension member by a first fastener and the bracket operably connected to the connection member via a second fastener.

FIG. 59 is a view of an extension member of a truck bed extension system; the view showing the extension member having a core member and a telescoping member extending outward from the core member; the view also showing a fastener securely connecting the telescoping member to the core member.

FIG. 60A is a view of a sidewall of a truck bed.

FIG. 60B is a view of an extension member of a truck bed extension system.

FIG. 60C is a view of an extension member of a truck bed extension system and a sidewall of a truck bed; the view showing the truck bed extension system operably installed in the truck bed by securely engaging a telescoping member of the extension member with the sidewall of the truck bed.

FIG. 61 is a view of a truck bed extension system installed in a truck bed; the system having a pair of extension members with core members and telescoping members operably connected to the truck bed; the system also having a pair of connection members operably connected to the pair of extension members; the view also showing a first set of extension straps connected to the truck and an extension member.

FIG. 62 is a top view of a truck bed extension system resting in a truck bed when not in use.

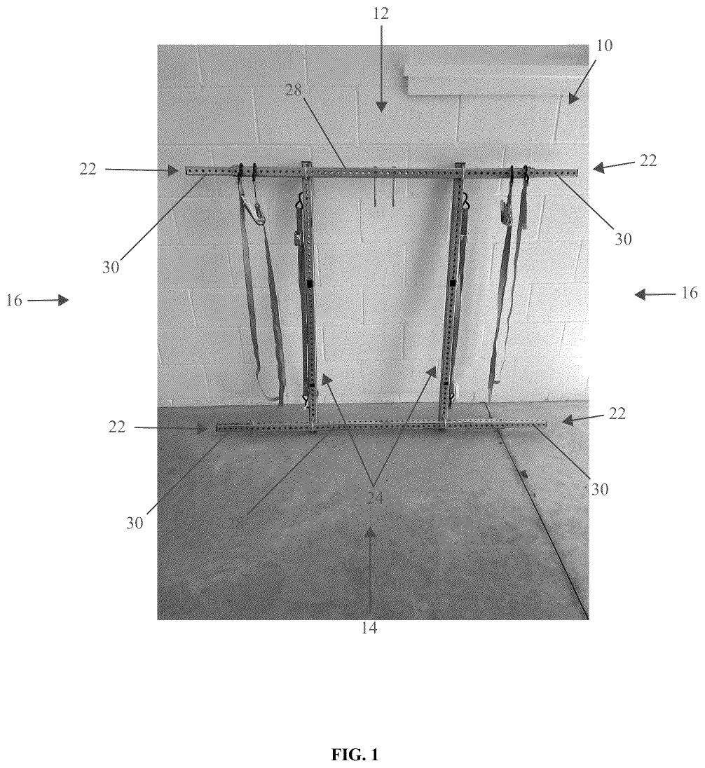

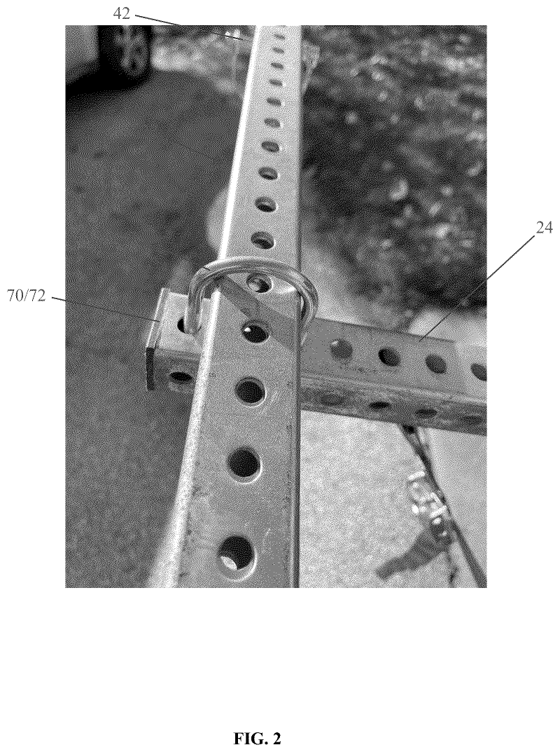

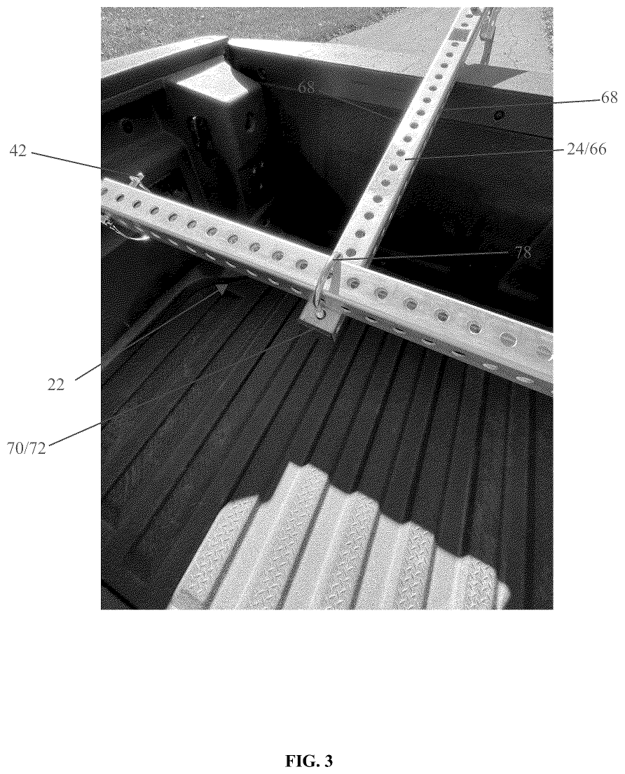

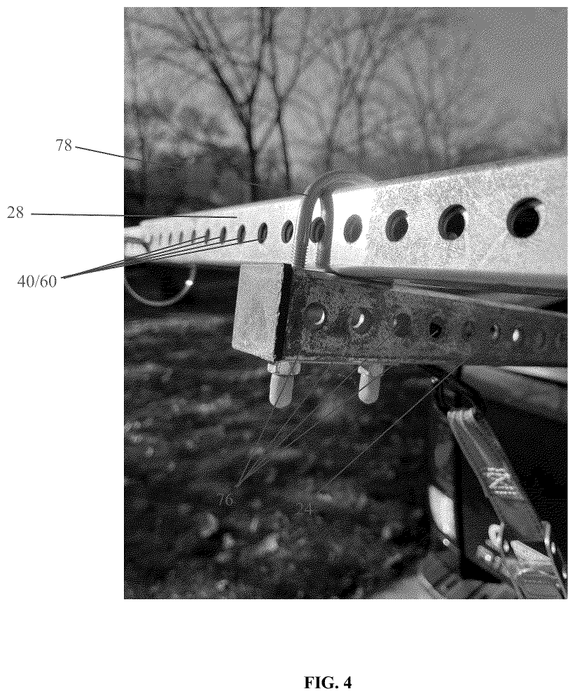

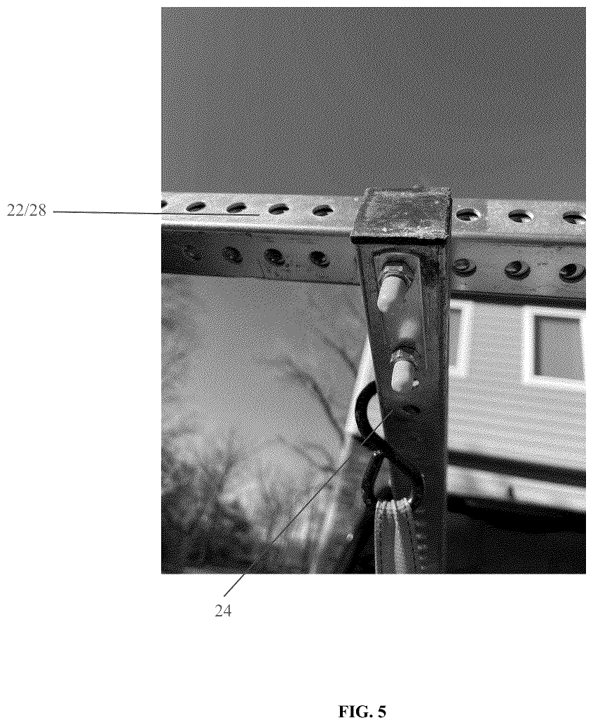

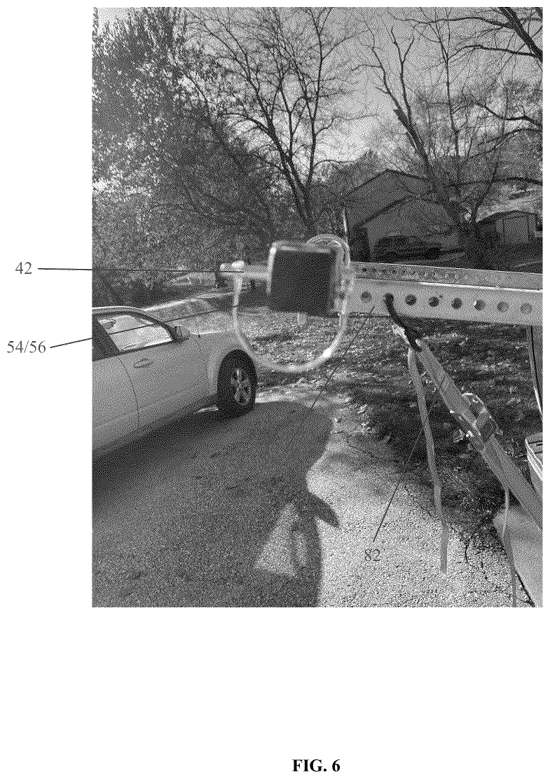

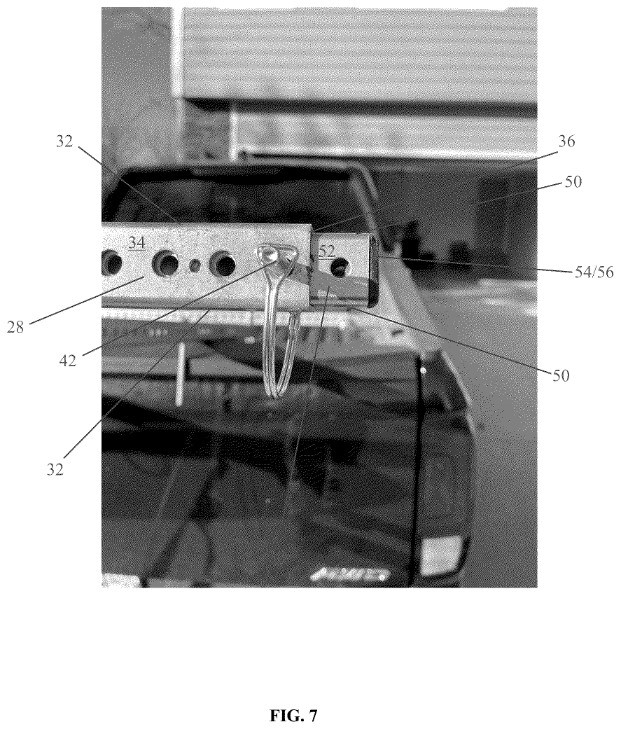

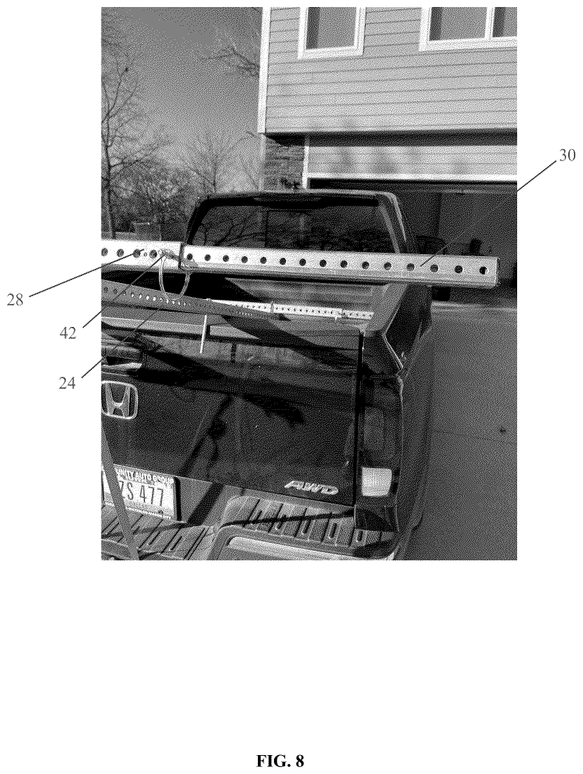

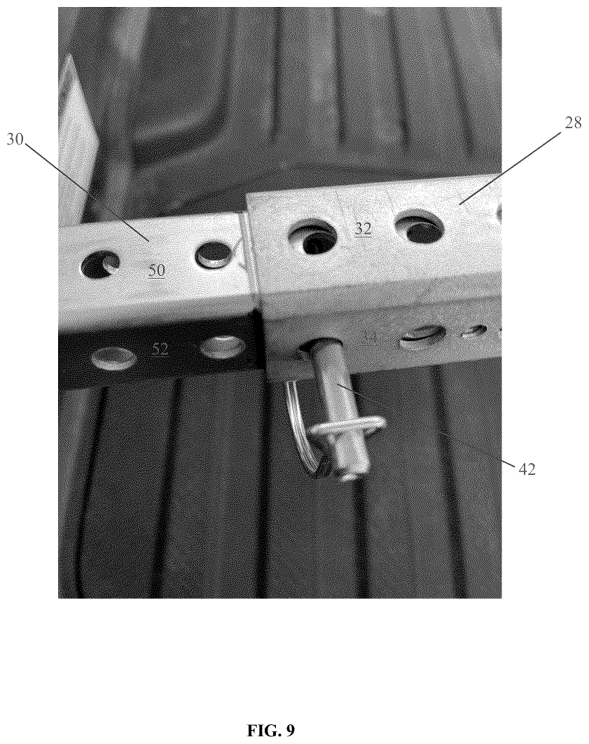

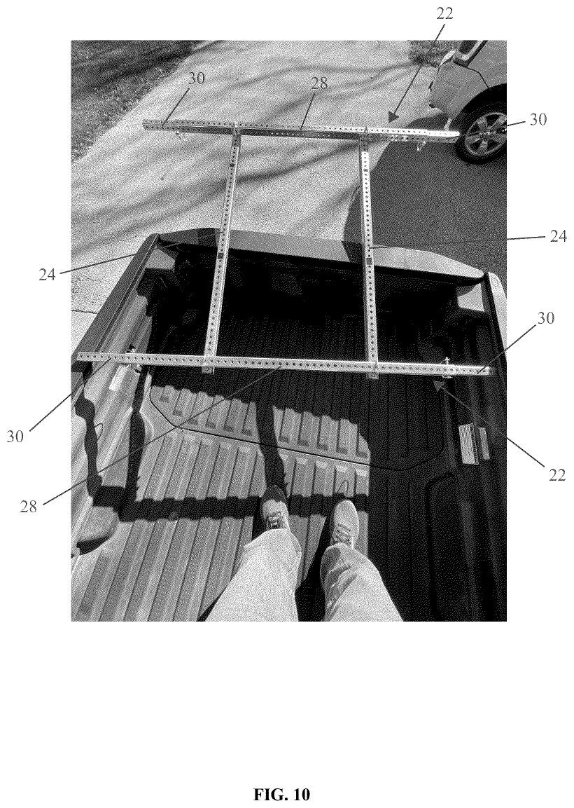

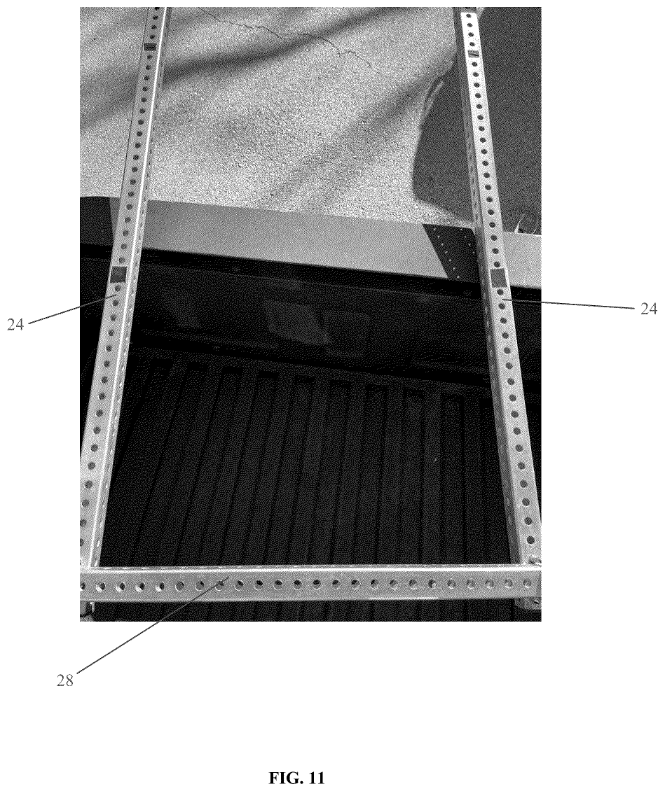

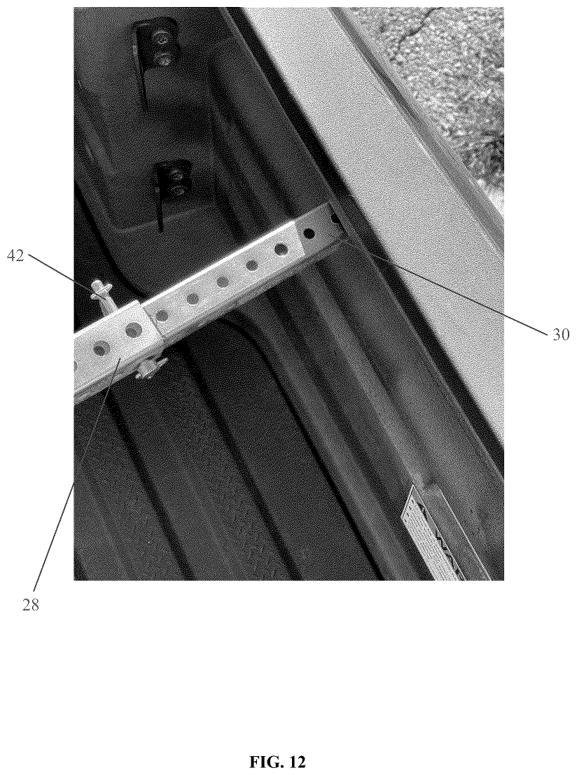

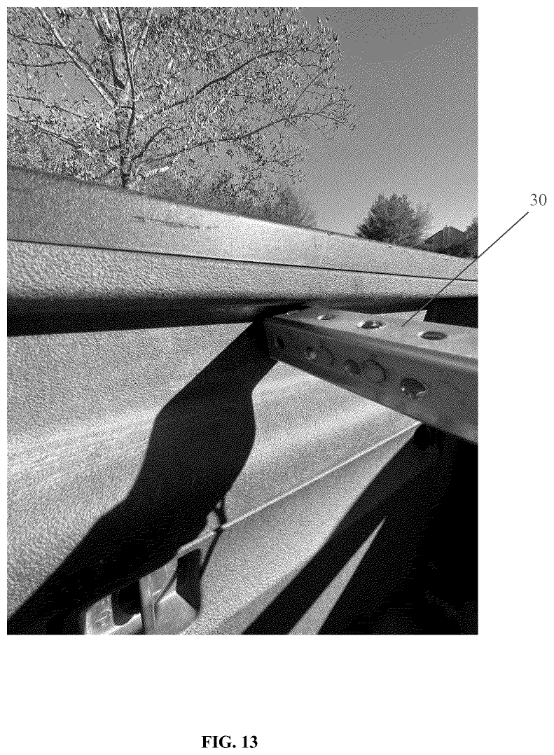

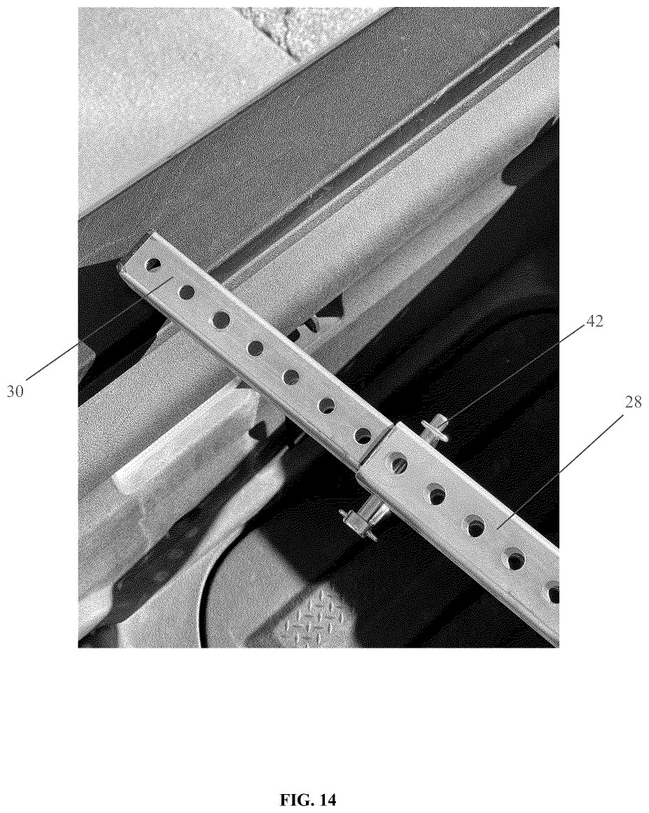

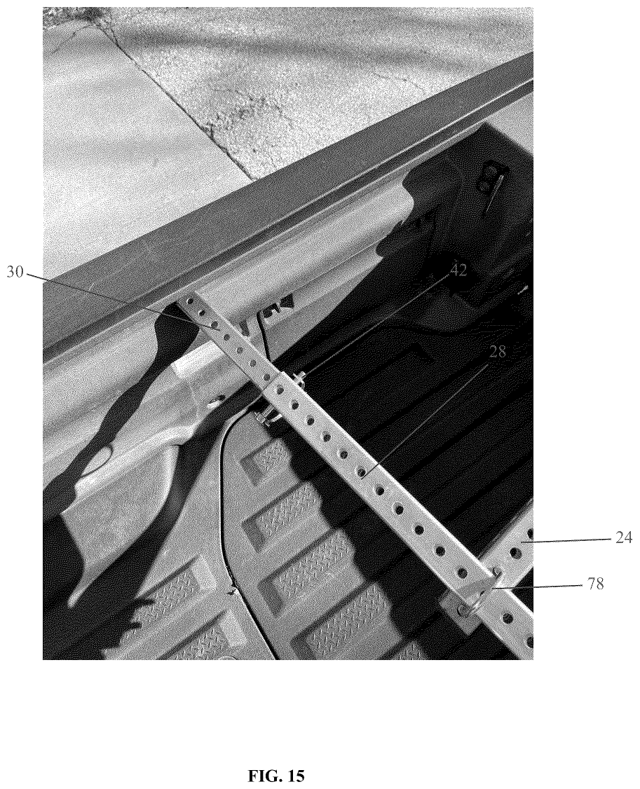

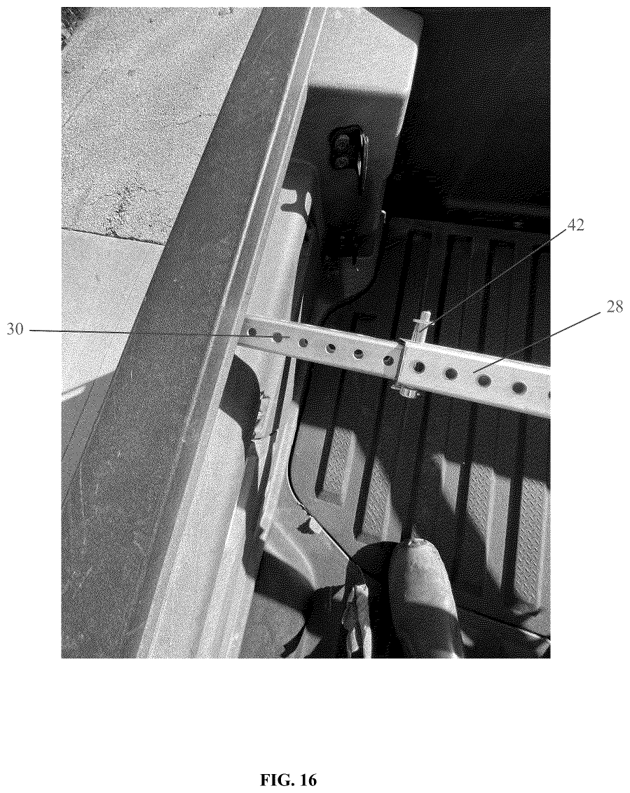

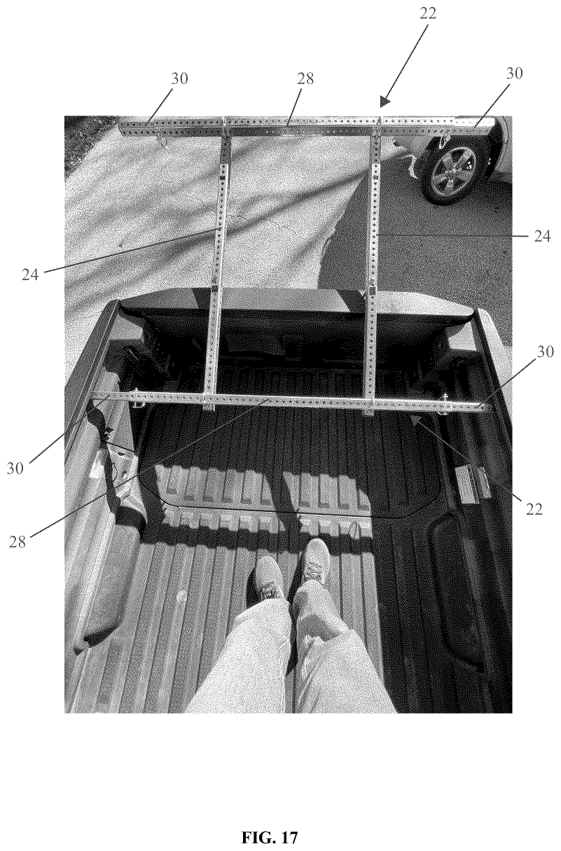

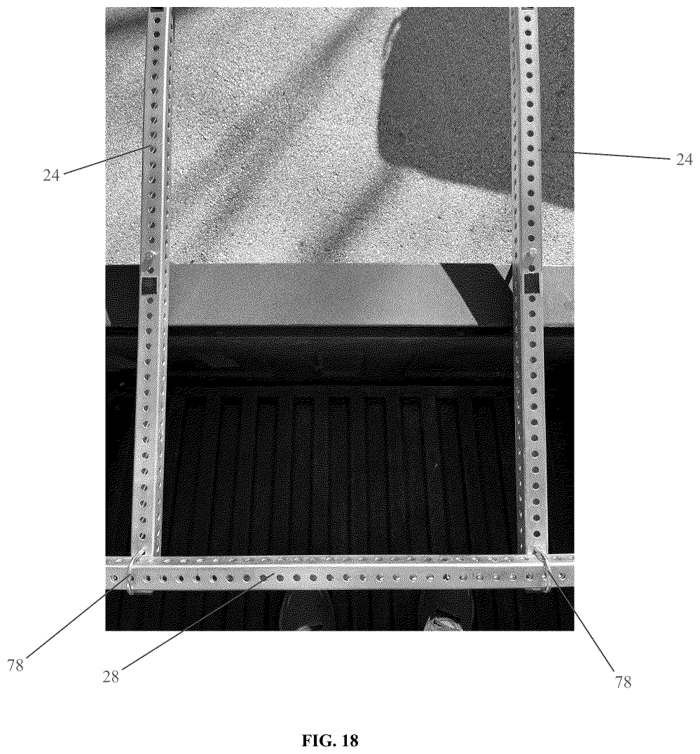

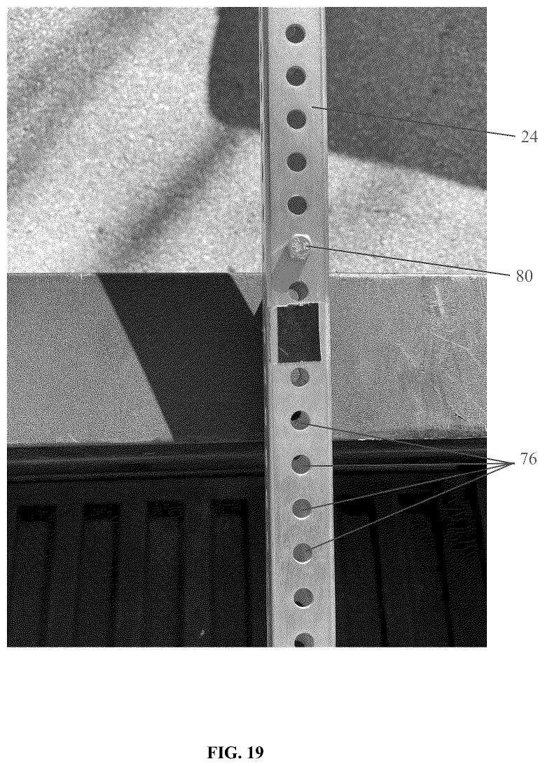

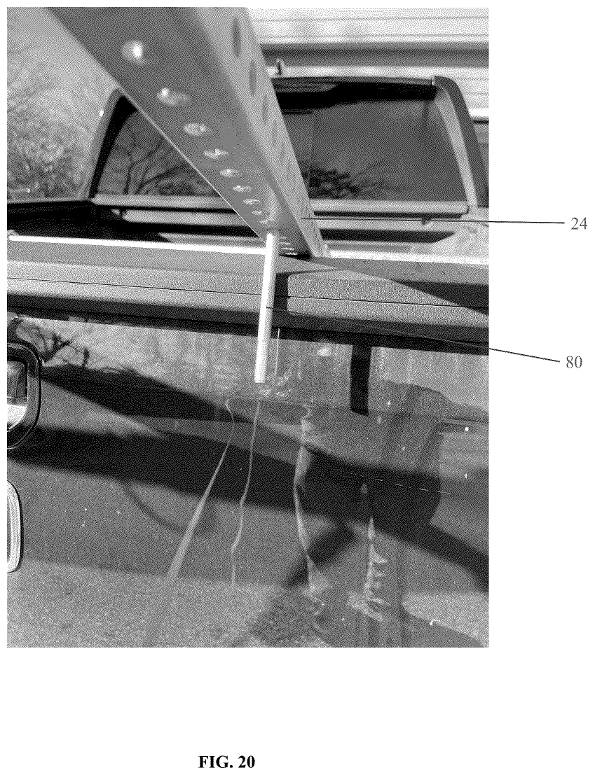

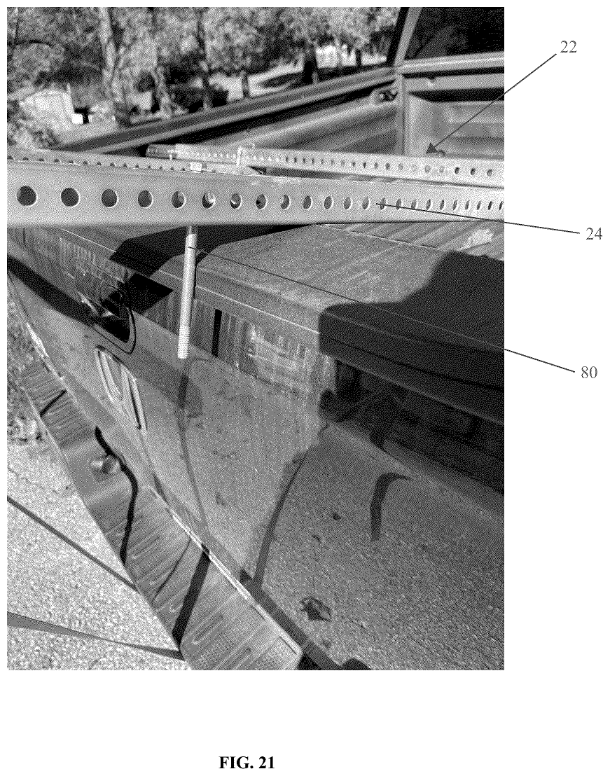

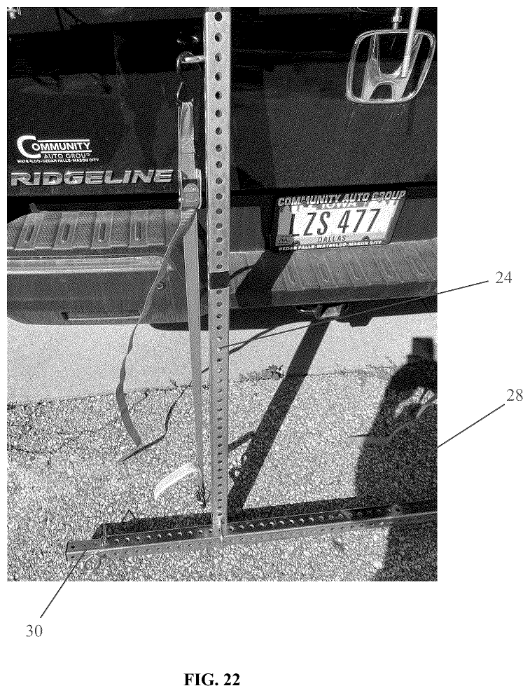

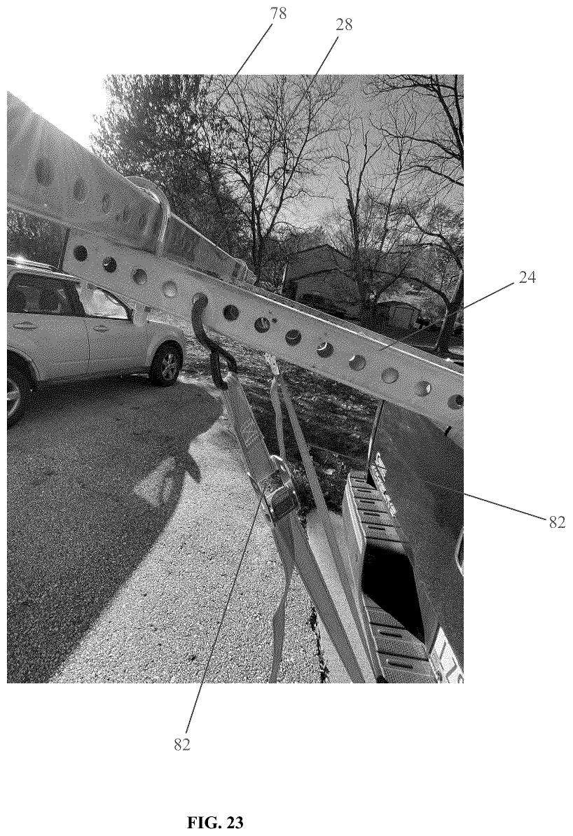

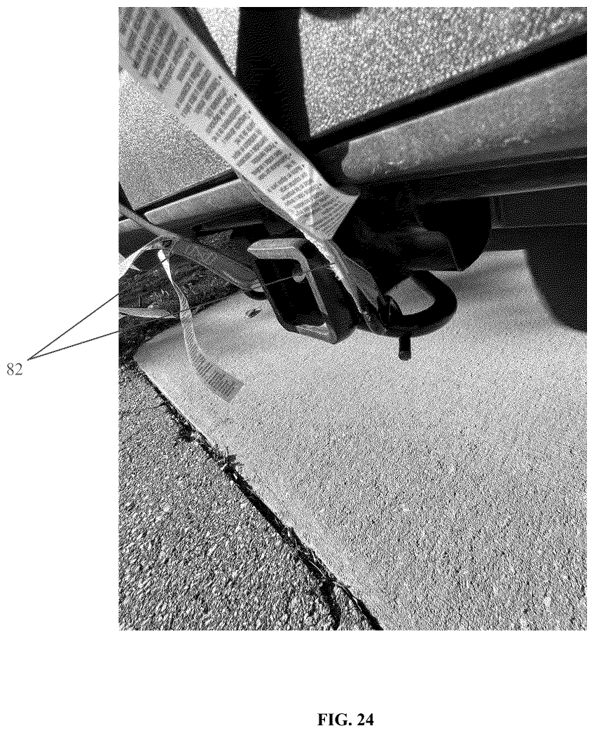

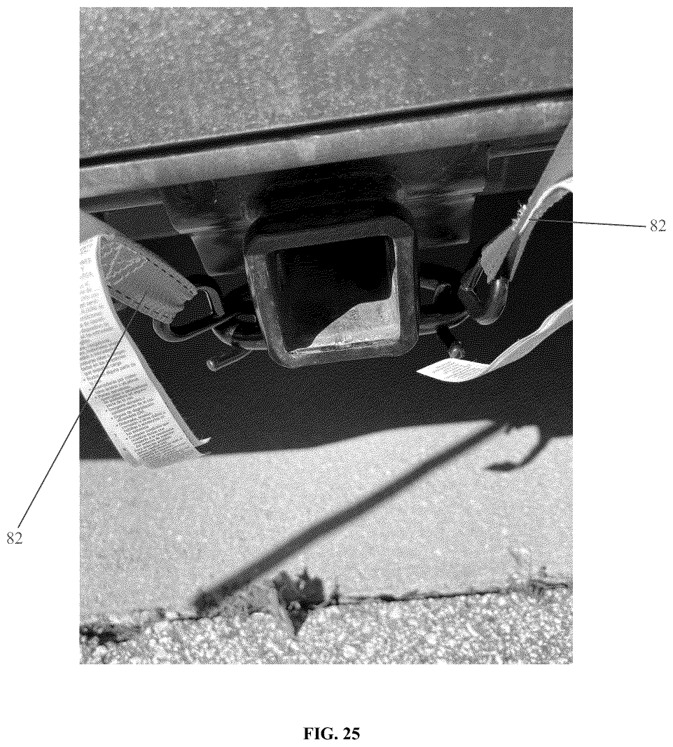

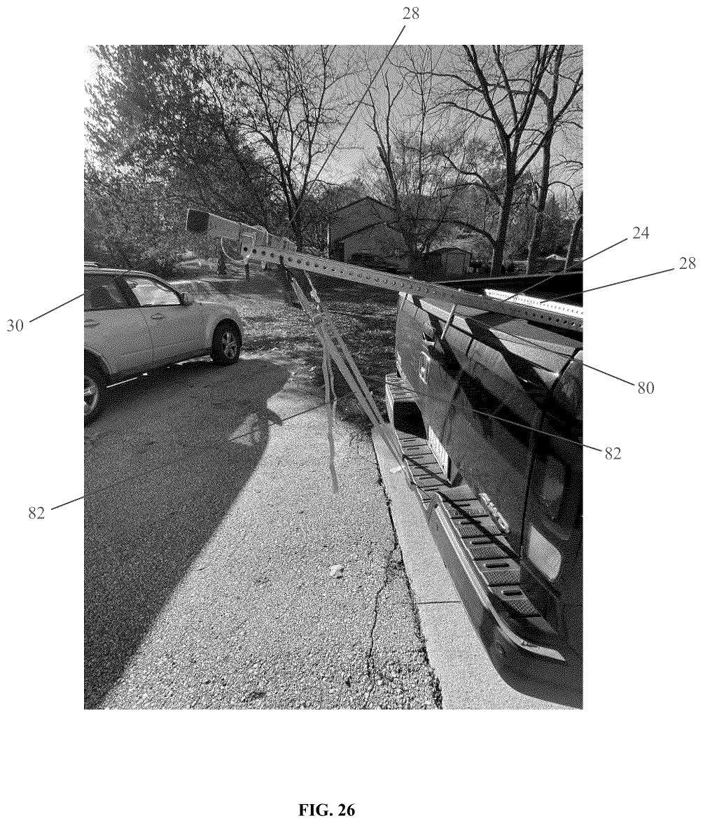

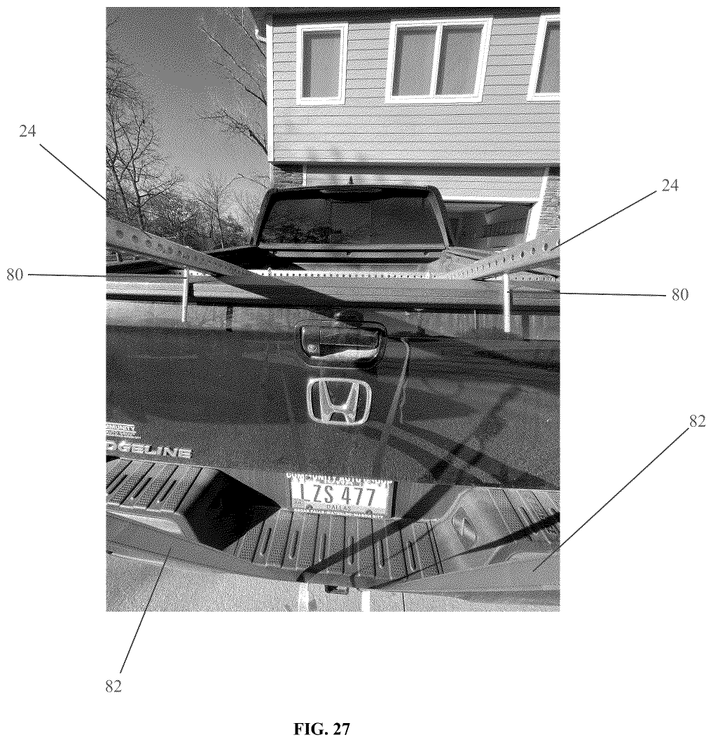

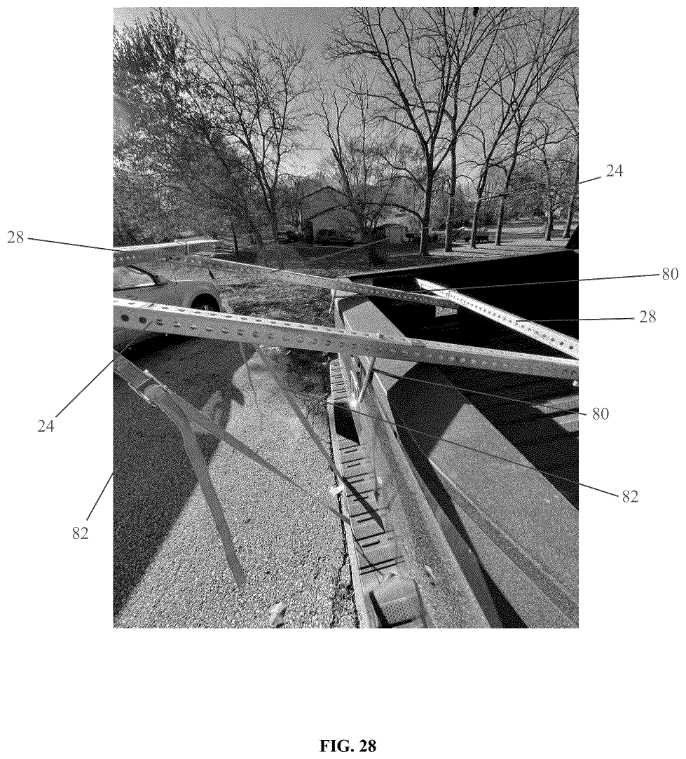

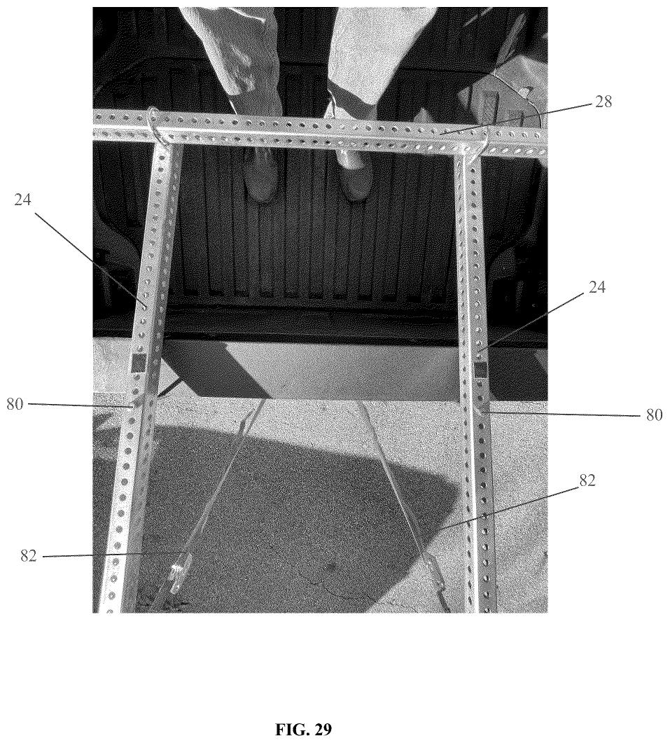

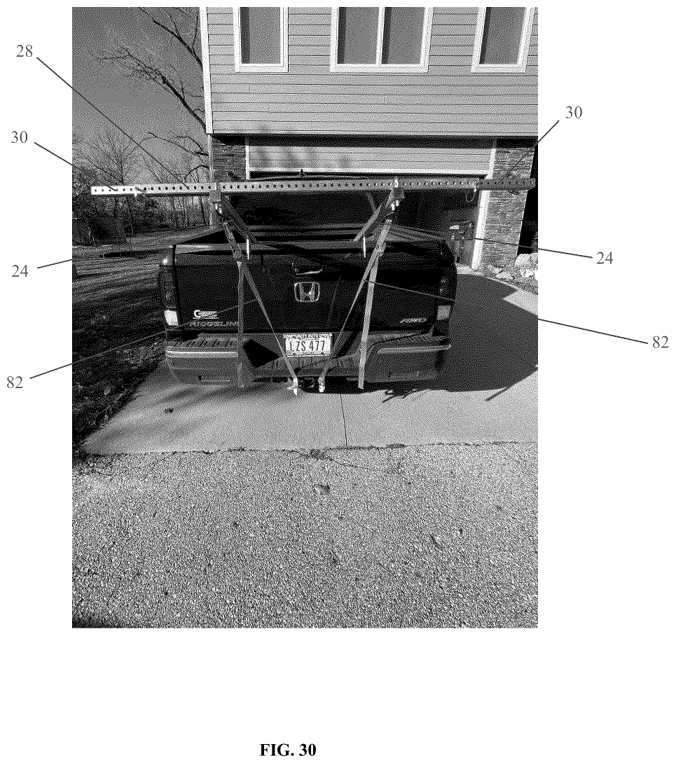

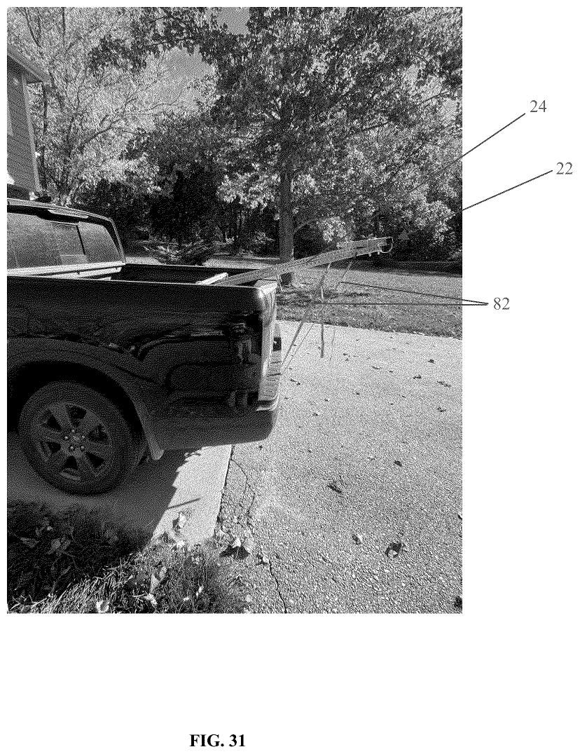

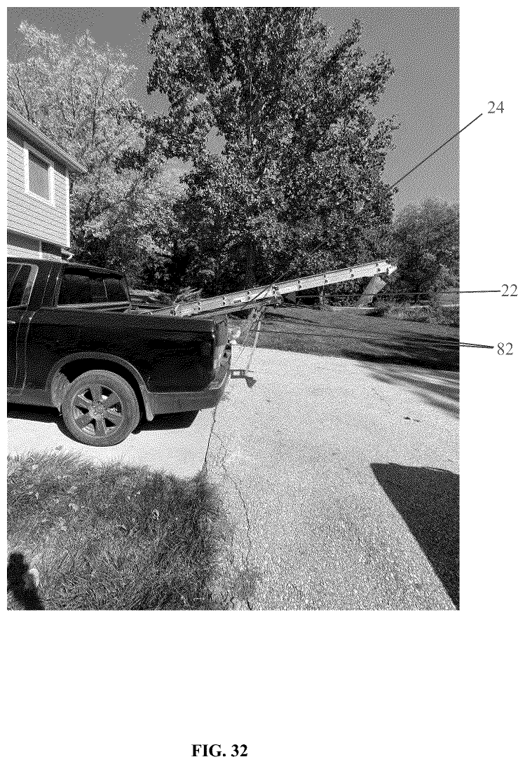

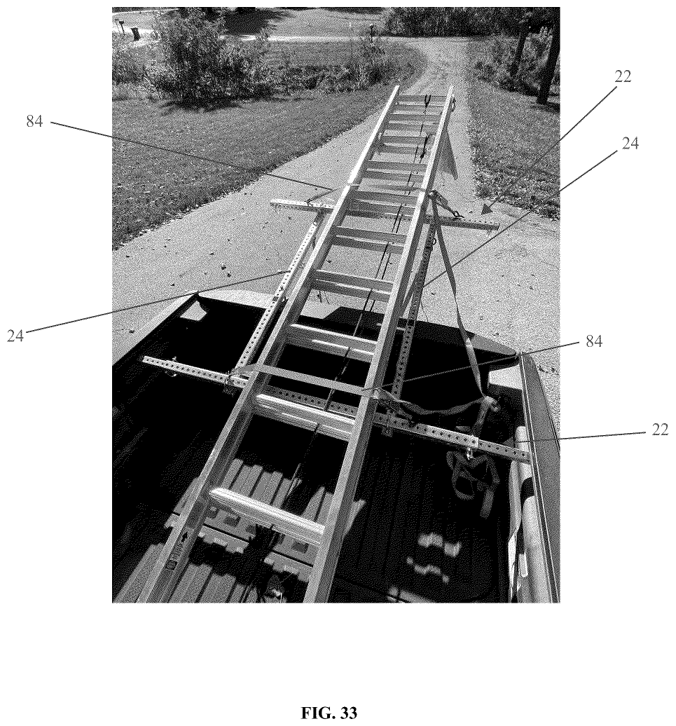

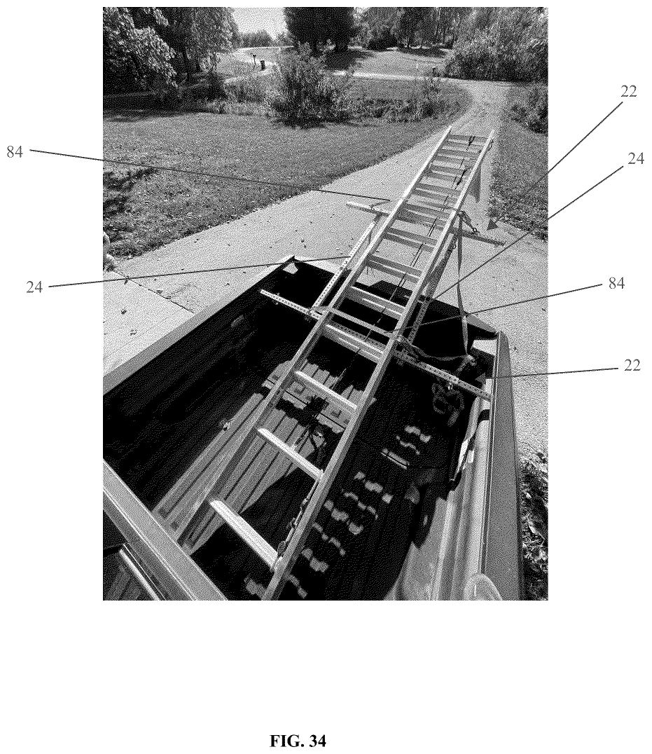

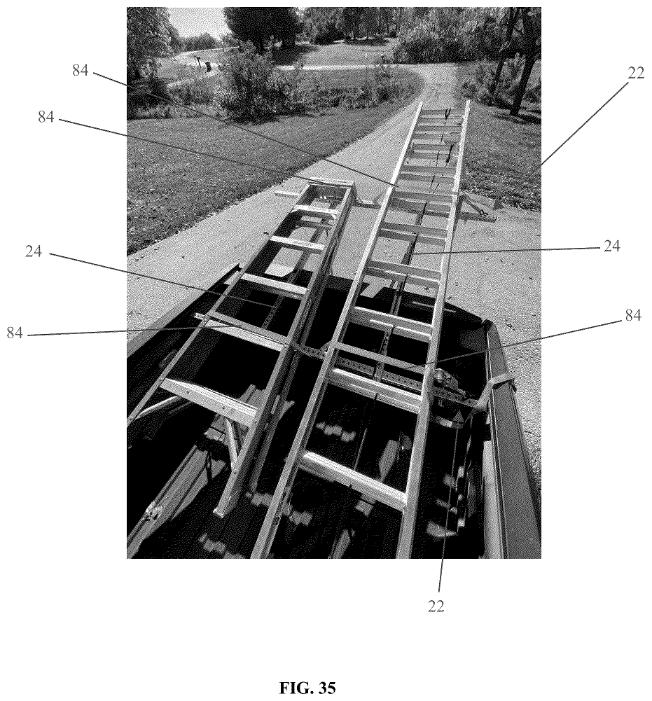

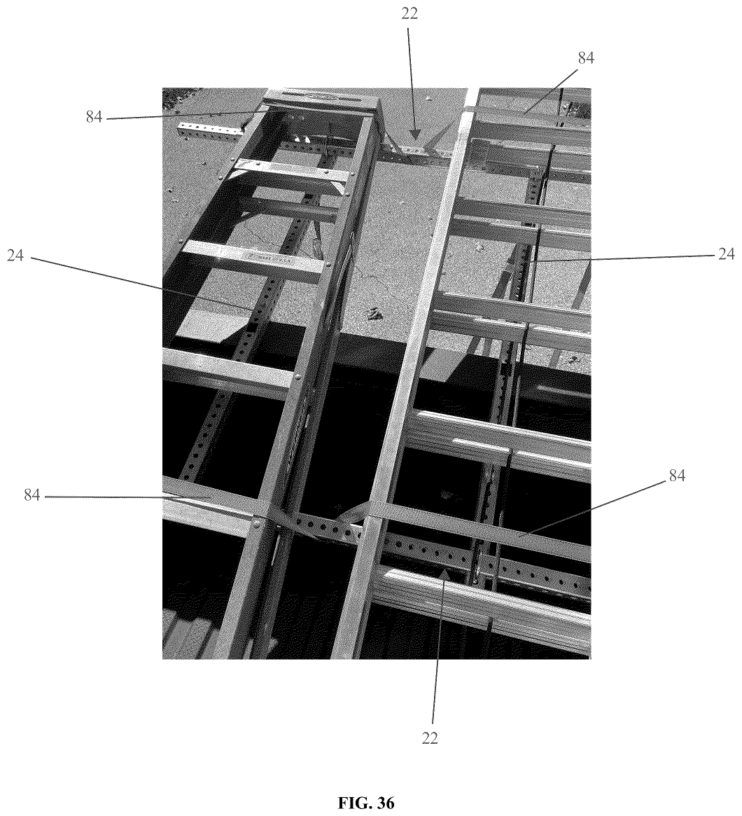

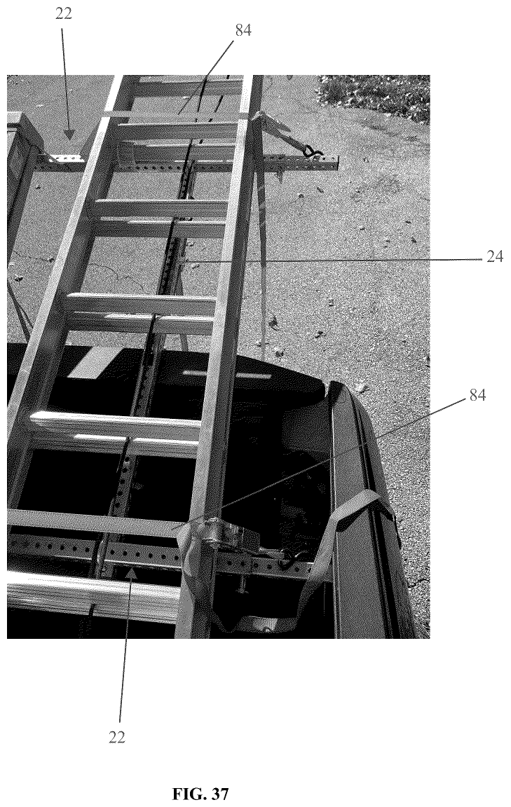

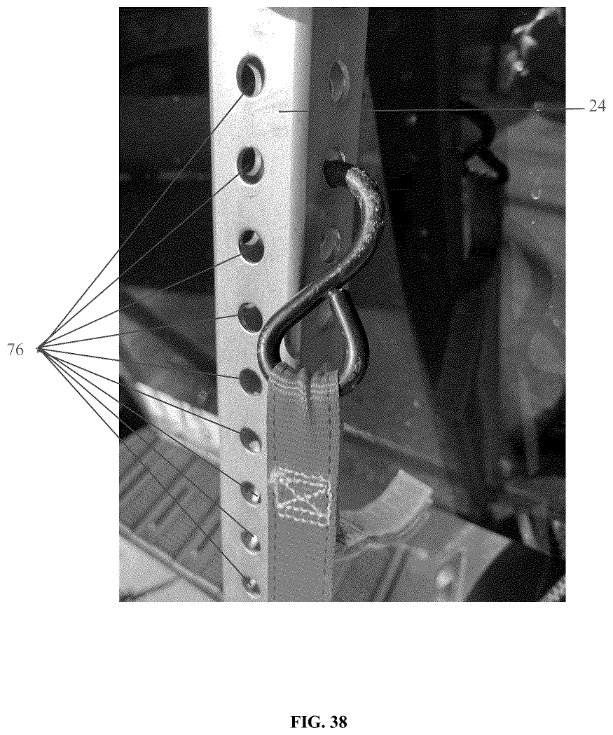

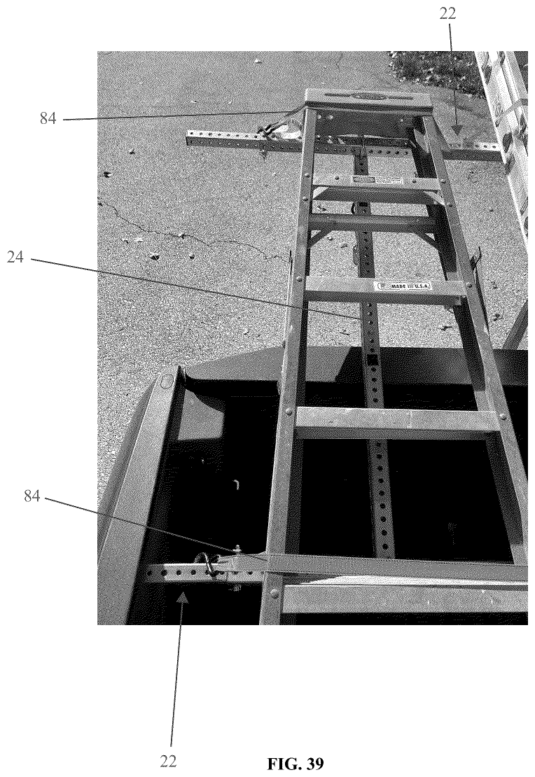

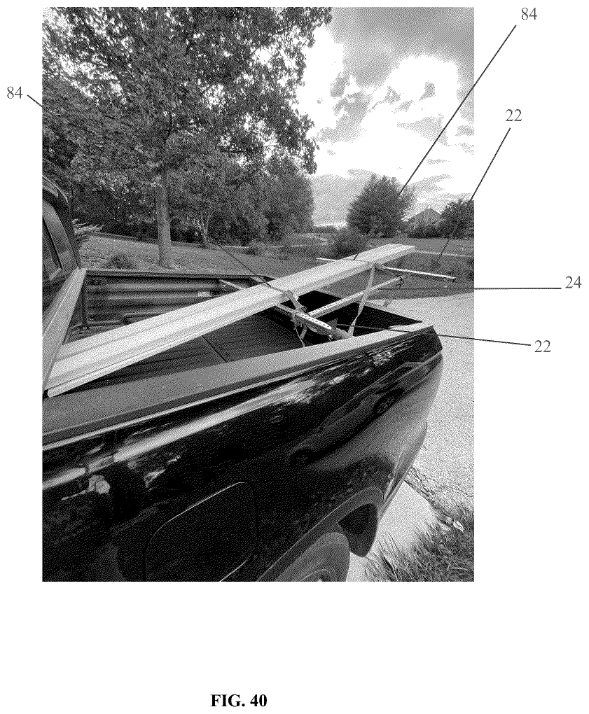

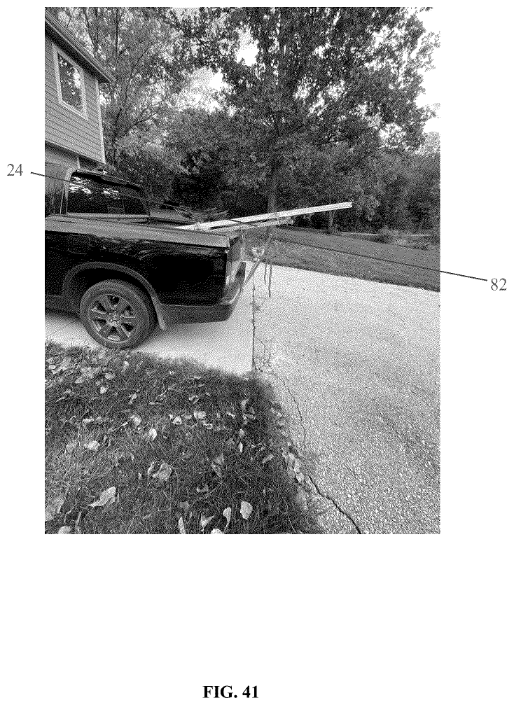

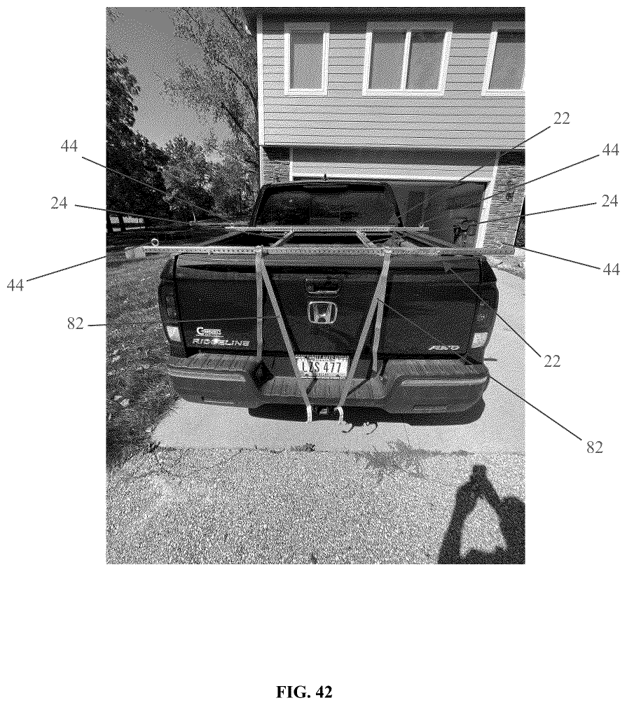

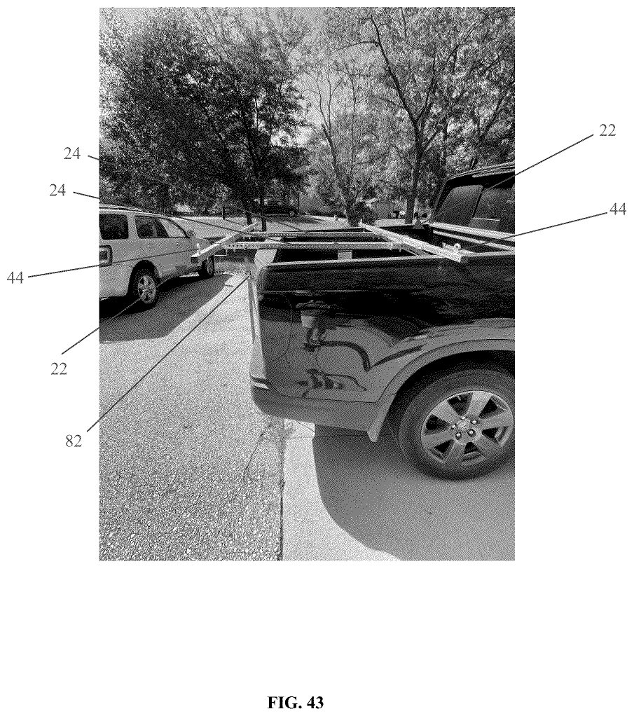

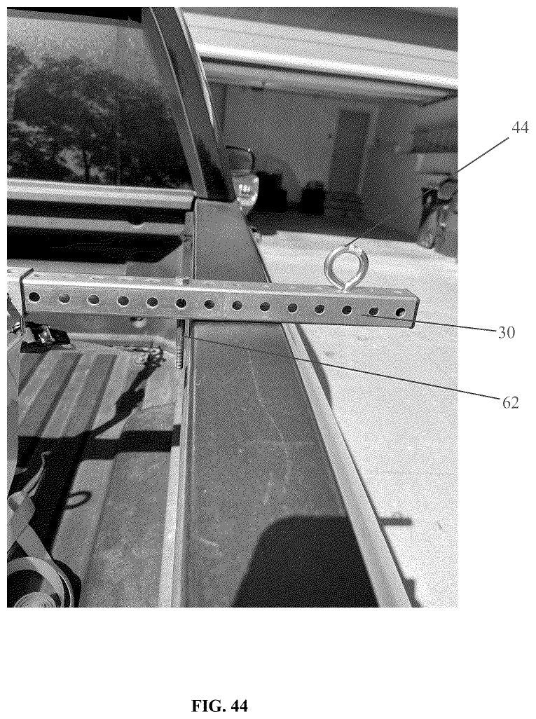

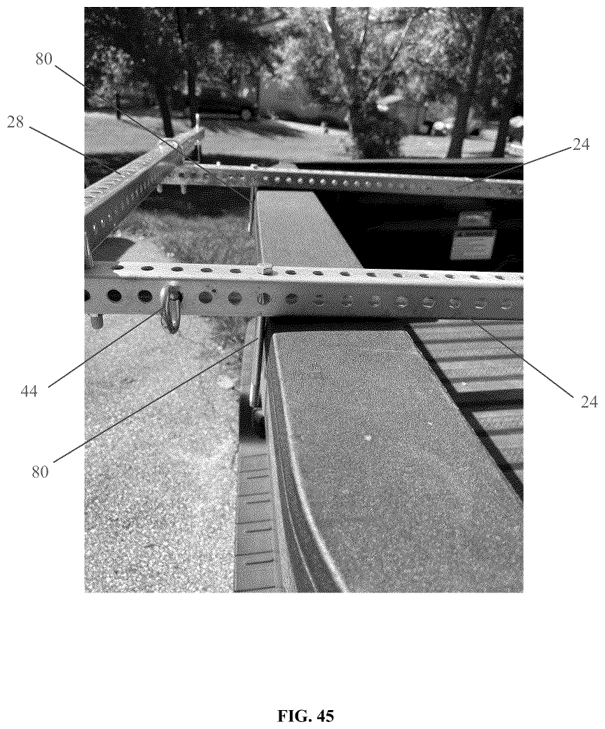

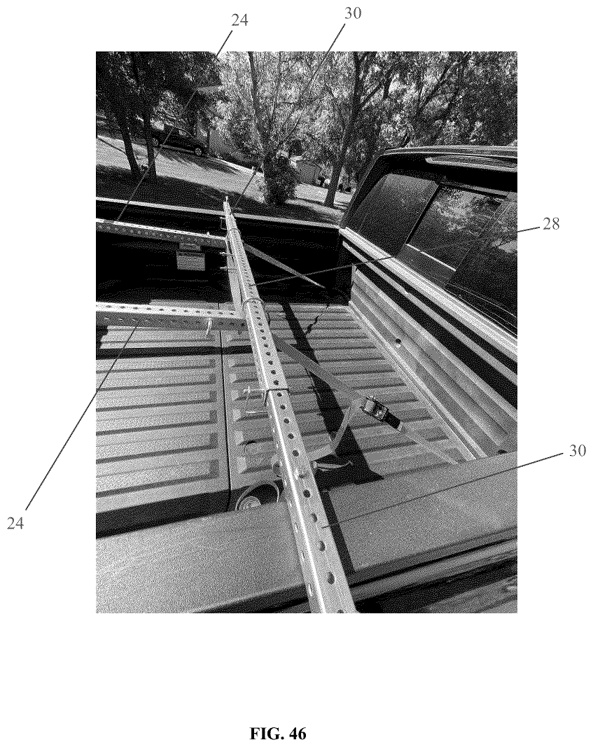

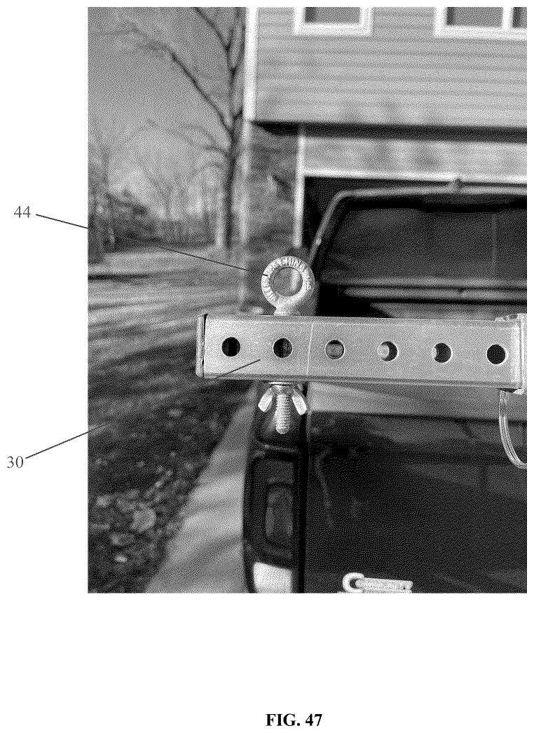

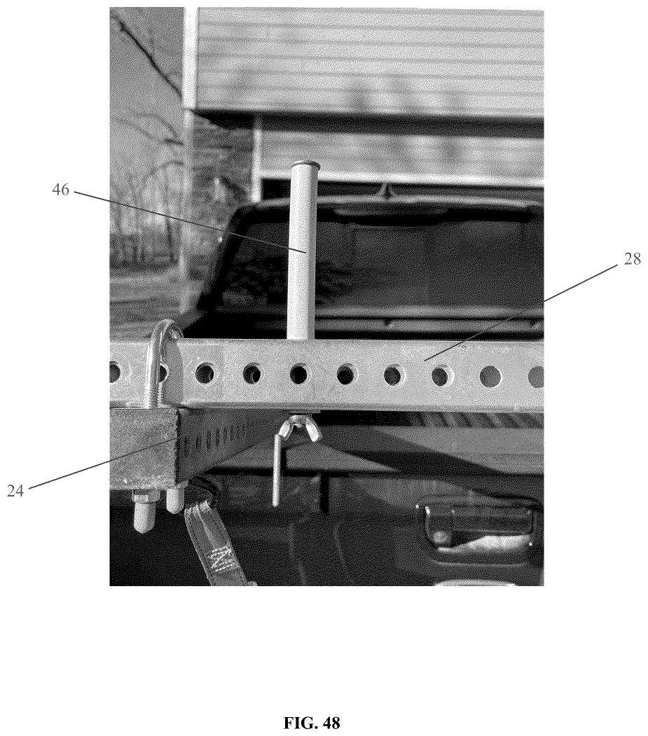

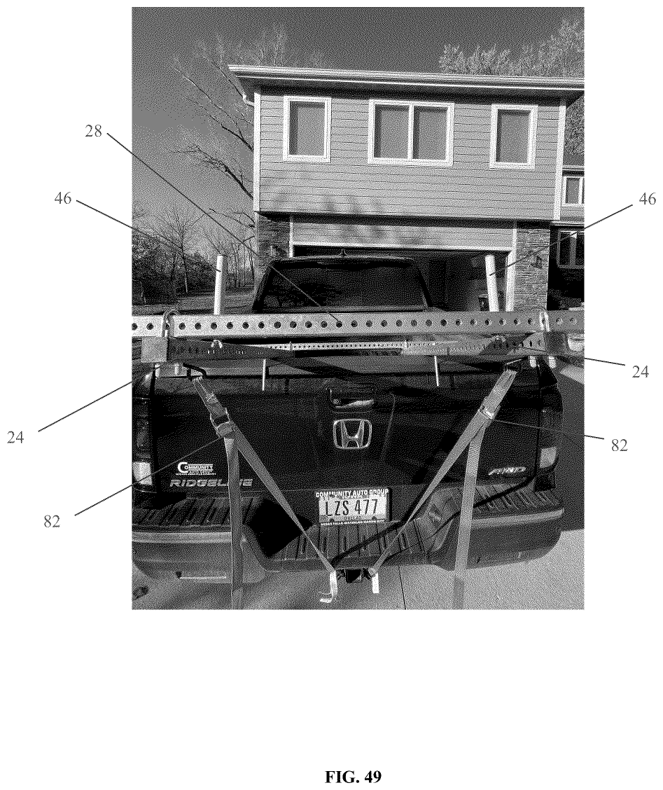

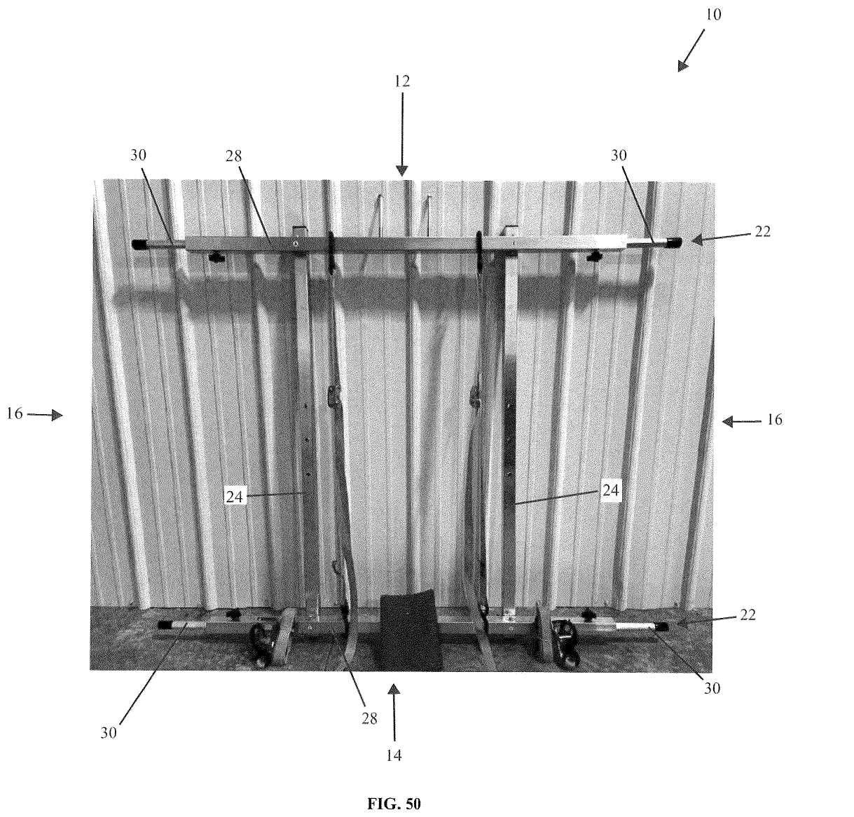

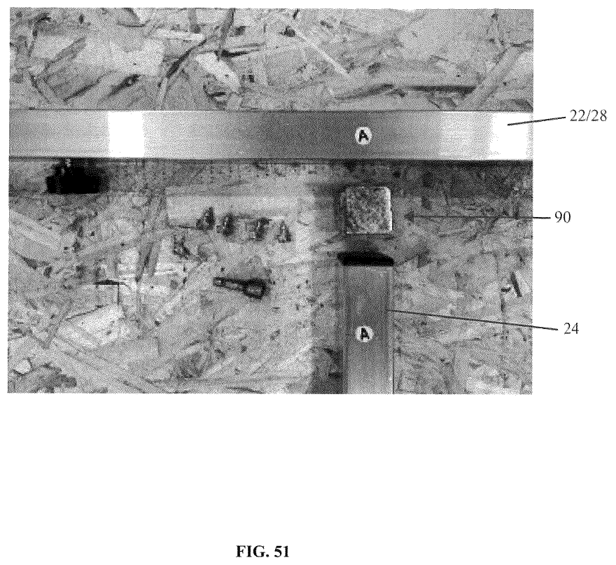

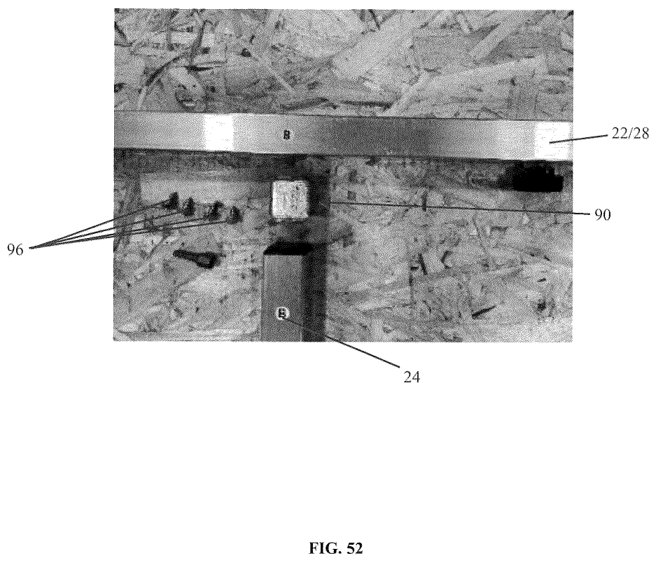

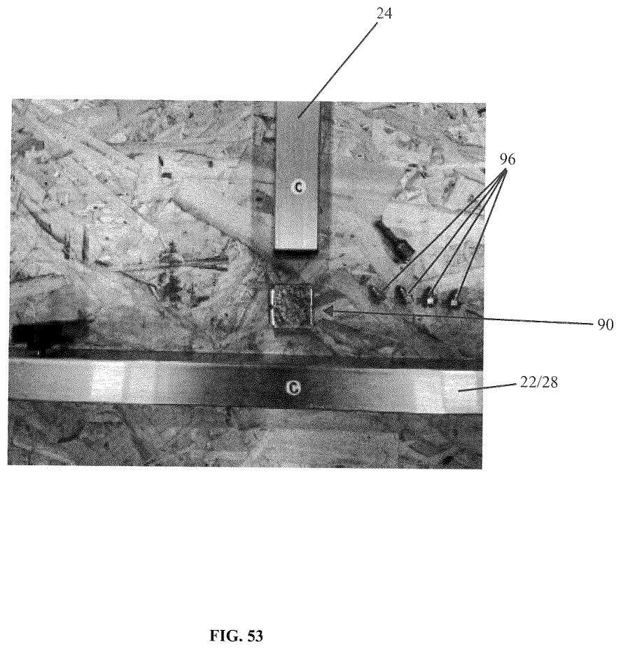

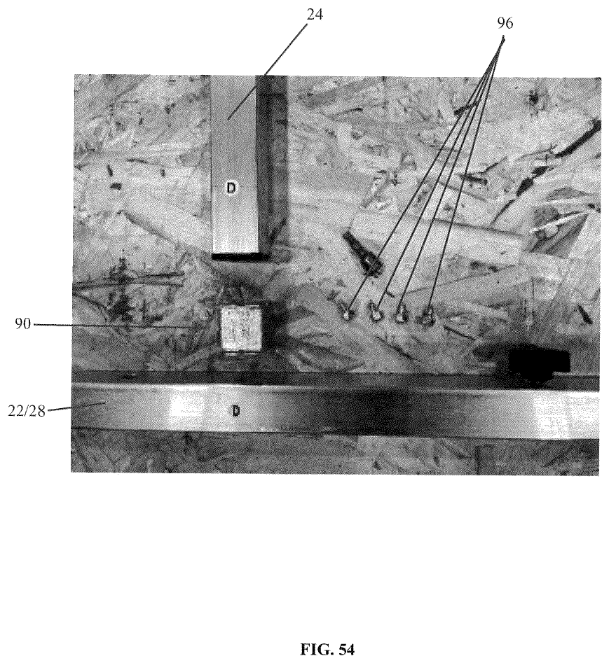

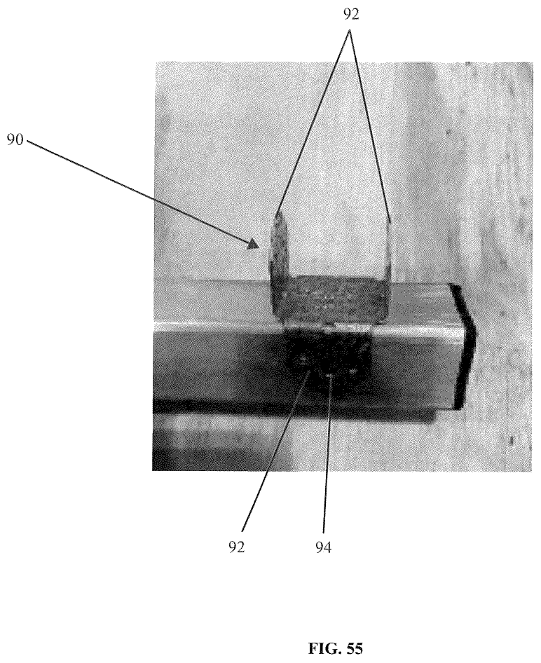

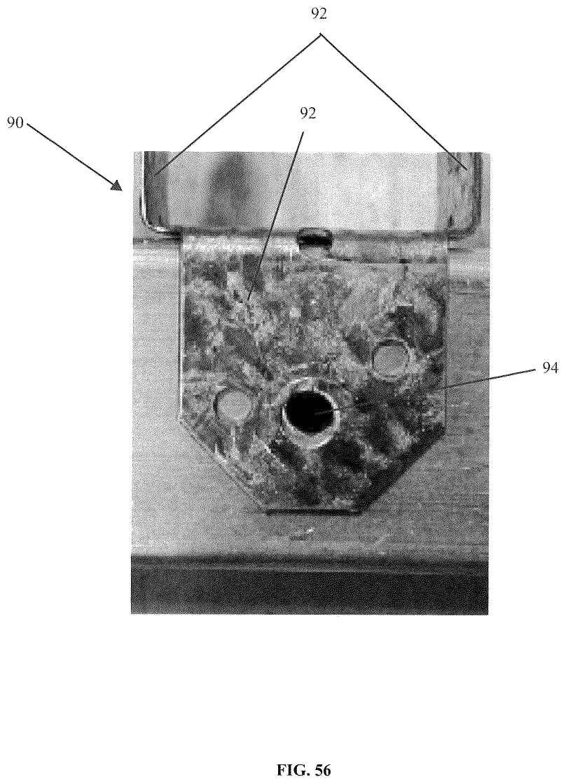

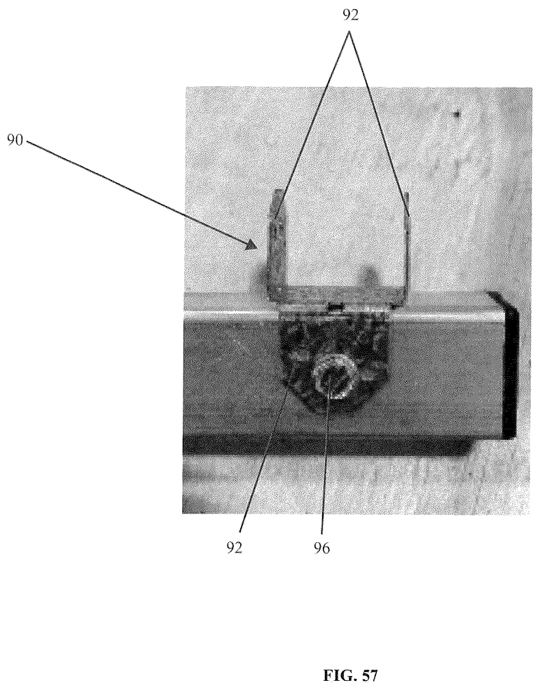

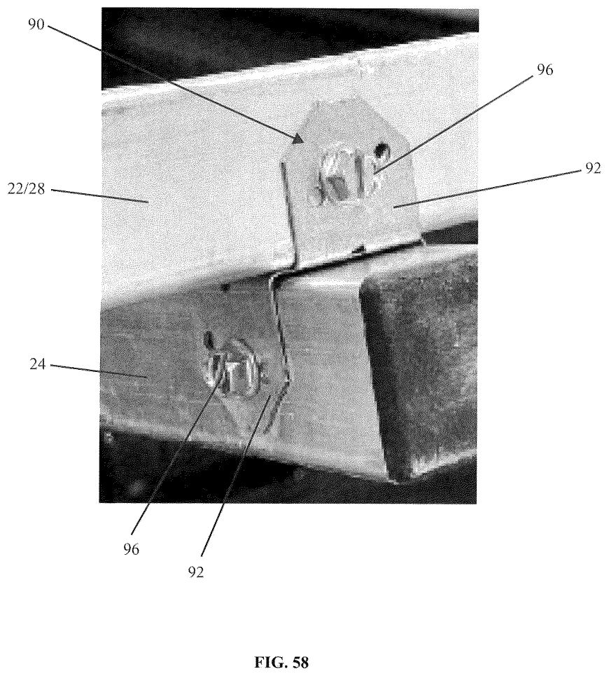

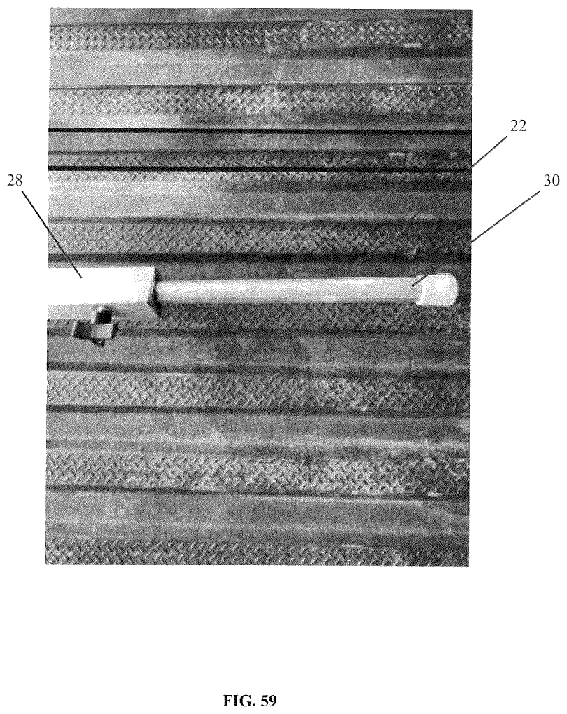

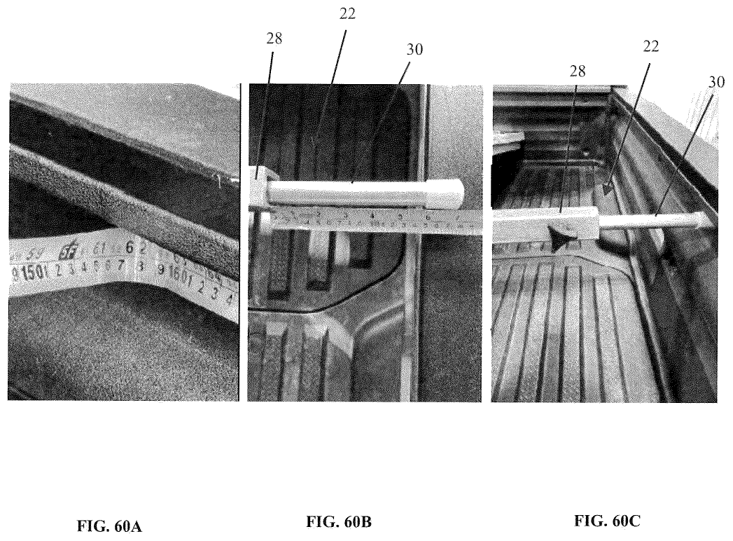

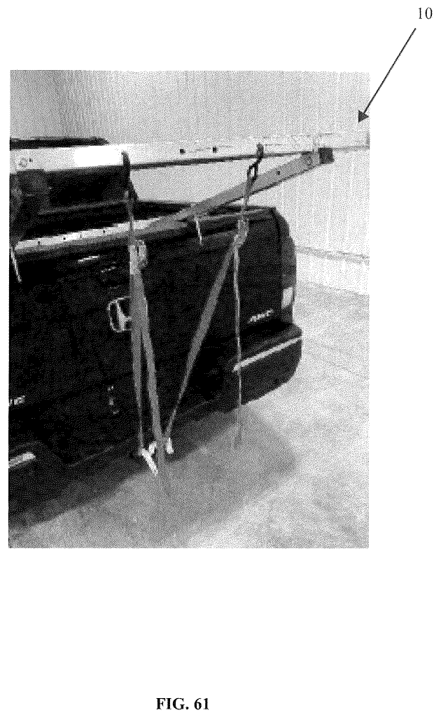

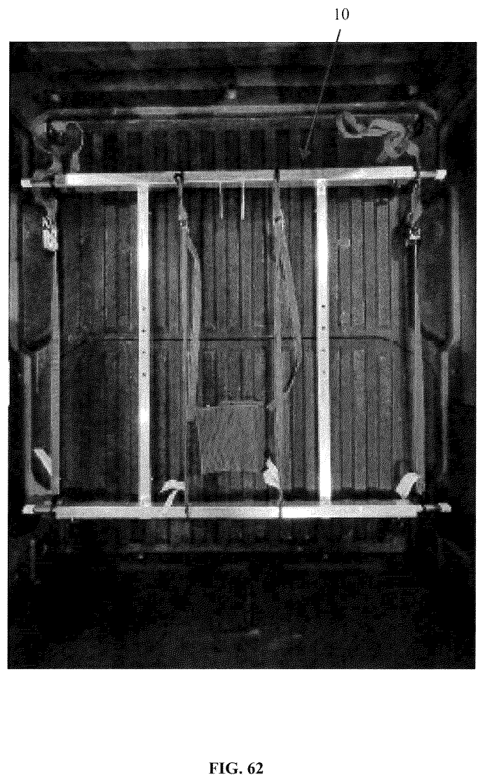

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively” or “operably”, such as when used as “operatively connected” or “operably engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of a truck bed extension system. However, the embodiments are not so limited. It is appreciated that the embodiments may be adapted for use in other applications which may be improved by the disclosed structures, arrangements and/or methods. The system is merely shown and described as being used in the context of truck beds for ease of description and as one of countless examples.

### Truck Bed Extension System

With reference to the figures, a truck bed extension system 10 (or simply “system 10”) is presented. System 10 is formed of any suitable size, shape, and design and is configured to effectively extend the working length and/or width of a truck bed. In one or more arrangements, as examples, system 10 has a forward end 12, a rearward end 14, opposing left and right sides 16 (or simply “sides 16”), a top side 18, and a bottom side 20. In one or more arrangements, as examples, system 10 includes extension members 22 and connection members 24, among other components as described herein. In one or more arrangements, as examples, system 10 also includes a first set of straps 82 and a second set of straps 84. While system 10 and its various components have been described with reference to the arrangement shown, as one example, any combination or arrangement of system 10 and its various components may be used and is hereby contemplated for use.

### Extension Members 22:

In one or more arrangements, as examples, system 10 includes extension members 22. Extension members 22 are formed of any suitable size, shape, and design and are configured to help effectively extend the working length and/or width of a truck bed. In one or more arrangements, as examples, extension members 22 include core members 28 and telescoping members 30. In one or more arrangements, as examples, there are two extension members 22. However, in various alternative arrangements, as examples, there may be any other number of extension members 22 including one extension member 22, three extension members 22, four extension members 22, or any other number of extension members 22.

### Core Members 28:

In one or more arrangements, as examples, each extension member 22 includes a core member 28. Core members 28 are formed of any suitable size, shape, and design and are configured to form a base for extension members 22 and help facilitate connection of extension members 22 to connection members 24. In one or more arrangements, as examples, core members 28 have opposing top and bottom surfaces 32, opposing sides 34, and opposing ends 36. In one or more arrangements, as examples, core members 28 include a hollow center 38, openings 40, and fasteners 42. In one or more arrangements, as examples, core members 28 may also include eye bolts 44 and dowels 46.

In one or more arrangements, as examples, core members 28 are formed of a single, unitary member that is formed in a manufacturing process such as machining, extrusion, forming, bending, additive manufacturing, or the like to form a unitary and monolithic member. Alternatively, core members 28 may be formed of multiple pieces that are connected or assembled to one another through welding, however any other means of connecting or assembling the multiple pieces may be used, including screwing, bolting, friction fitting, or the like. In one or more arrangements, as examples, core members 28 are formed primarily of a metallic material such as steel, aluminum, chromium, or any other metallic material, alloy, and/or composite thereof. Alternatively, core members 28 may be formed of a non-metallic material such as a plastic material, a fiberglass material, or any other non-metallic material and/or composite thereof.

In one or more arrangements, as examples, core members 28 are steel square tubes. However, core members 28 are not so limited and, in one or more arrangements as examples, core members 28 may be any other shape, design, or configuration of elongated material. In one or more arrangements, as examples, when viewed from top side 18 of system 10, core members 28 are generally rectangular in shape, with the opposing sides 34 extending in approximate parallel planar spaced relation to one another and in approximate perpendicular planar relation to opposing ends 36. In one or more arrangements, as examples, when viewed from either forward end 12 or rearward end 14 of system 10, core members 28 are generally rectangular in shape, with opposing top and bottom surfaces 32 extending in approximate parallel planar spaced relation to one another and in approximate perpendicular planar relation to opposing ends 36. In one or more arrangements, as examples, when viewed from either side 16 of system 10, core members 28 are generally square in shape, with opposing top and bottom surfaces 32 extending in approximate parallel planar spaced relation to one another and in approximate perpendicular planar relation to opposing sides 34.

In one or more arrangements, as examples, core members 28 include a hollow center 38. Hollow center 38 is formed of any suitable size, shape, and design and is configured to allow for telescoping members 30 of extension members 22 to be inserted into, and move along a length of, core members 28. In one or more arrangements, as examples, hollow center 38 is a generally square opening in core members 28 which extends from one opposing end 36 to the other opposing end 36 of core members 28. In one or more arrangements, as examples, hollow center 38 may be sized such that telescoping members 30 fit within relatively close and tight tolerances in hollow center 38 such that telescoping members 30 only move along a length of core members 28 when a user pushes or pulls telescoping members 30 with sufficient force to overcome the force of friction between telescoping members 30 and core members 28. In one or more arrangements, as examples, hollow center 38 may be sized such that telescoping members 30 are not held within close and tight tolerances and telescoping members 30 may slide relatively freely along a length of core members 28 with little force required to cause such sliding.

In one or more arrangements, as examples, hollow center 38 may be formed in the manufacturing process of the core member 28, such as when core member 28 is manufactured using a forming or bending process. In one or more alternative arrangements, as examples, where core members 28 are manufactured using a machining process, hollow center 38 may be formed by the removal of material in the center of core members 28. In one or more alternative arrangements, as examples, where core members 28 are manufactured using an additive manufacturing process, hollow center 38 may be created due to the lack of added material in the center of core members 28.

In one or more arrangements shown, as examples, core members 28 may include openings 40. Openings 40 are formed of any suitable size, shape, and design and are configured to allow for pins, fasteners, dowels, or other features to be inserted into and through core members 28 for various purposes. In one or more arrangements shown, as examples, openings 40 are circular perforations which are present throughout the length of core members 28 and approximately equally spaced from one another. Said another way, in one or more examples a first opening 40 is present near one opposing end 36 of core members 28, a second opening 40 is present near the other opposing end 36 of core members 28, and additional openings 40 are present in between the first opening 40 and the second opening 40 and such additional openings 40 are approximately equally spaced apart from one another.

In one or more arrangements, openings 40 are configured to receive and hold various different pins, fasteners, dowels, or other features in order to help secure system 10 or perform other functions necessary for using system 10. In one or more arrangements, as examples, openings 40 may be configured to receive one or more eye bolts 44. Eye bolts 44 are formed of any suitable size, shape, and design and are configured to help properly secure the material being hauled using system 10 to system 10. In one or more arrangements, as examples, openings 40 may be configured to receive one or more dowels 46. Dowels 46 are formed of any suitable size, shape, and design and are configured to help prevent the material being hauled using system 10 from sliding past predetermined parameters, either from side-to-side or from front-to-back relative to the truck bed.

In one or more arrangements, as examples, core members 28 include fasteners 42. Fasteners 42 are formed of any suitable size, shape, and design and are configured to facilitate the locking of telescoping members 30 at desired positions. In one or more arrangements shown, as examples, fasteners 42 are wire lock pins. In one or more arrangements shown, as examples, fasteners 42 are thumb screws or knob screws. In one or more alternative arrangements, as examples, fasteners 42 may be any other type of fasteners such as a linchpin, a clevis pin and clip, a bolt and nut configuration, any other type of screw, or any other type, combination, and/or configuration of mechanism configured to lock telescoping members 30 at desired positions. In one or more arrangements, as examples, there are two fasteners 42, with one fastener 42 positioned near one opposing end 36 and a second fastener 42 positioned near the other opposing end 36 of core members 28. However, fasteners 42 are not so limited and in one or more arrangements, as examples, any other number and positioning of fasteners 42 may be used in order to facilitate the locking of telescoping members 30 at desired positions.

In one or more arrangements, as examples, fasteners 42 are configured to prevent telescoping members 30 from sliding along a length of core members 28 when telescoping members 30 are at a desired position. In one or more arrangements, as examples, telescoping members 30 are inserted into the hollow center 38 of core members 28 and slide along a length of core members 28 to a desired position, with openings 40 of core members 28 approximately concentric with openings 60 of telescoping members 30. Once the telescoping members 30 are at the desired position, a user can insert fasteners 42 through openings 40 in core members 28 and secure fasteners 42 appropriately (given the type of fasteners 42 used). Once fasteners 42 are properly secured, telescoping members 30 are locked in place.

### Telescoping Members 30:

In one or more arrangements, as examples, each extension member 22 includes telescoping members 30. Telescoping members 30 are formed of any suitable size, shape, and design and are configured to extend outward from core members 28 a desired distance in order to effectively extend the working length and/or width of a truck bed. In one or more arrangements, as examples, each extension member 22 has two telescoping members 30, with one telescoping member 30 extending outward from one opposing end 36 of core member 28 and the other telescoping member 30 extending outward from the other opposing end 36 of core member 28. In one or more arrangements, as examples, telescoping members 30 have opposing top and bottom surfaces 50, opposing sides 52, and ends 54 with end caps 56. In one or more arrangements shown, as examples, telescoping members 30 include a hollow center 58 and openings 60. In one or more arrangements, as examples, telescoping members 30 may include stabilizer pins 62 and any other feature or component including, but not limited to, eye bolts 44 and/or dowels 46.

In one or more arrangements, as examples, telescoping members 30 may be formed of a single, unitary member that is formed in a manufacturing process such as machining, extrusion, forming, bending, additive manufacturing, or the like to form a unitary and monolithic member. Alternatively, telescoping members 30 may be formed of multiple pieces that are connected or assembled to one another through welding, however any other means of connecting or assembling the multiple pieces may be used, including screwing, bolting, friction fitting, or the like. In one or more arrangements, as examples, telescoping members 30 are formed primarily of a metallic material such as steel, aluminum, chromium, or any other metallic material, alloy, and/or composite thereof. Alternatively, telescoping members 30 may be formed of a non-metallic material such as a plastic material, a fiberglass material, or any other non-metallic material and/or composite thereof.

In one or more arrangements, as examples, telescoping members 30 are steel perforated square tubes. However, telescoping members 30 are not so limited and, in one or more alternative arrangements as examples, telescoping members 30 may be any other shape, design, or configuration of elongated material including, but not limited to, elongated cylindrical members. In one or more arrangements, as examples, telescoping members 30 are sized such that they are able to fit inside hollow center 38 of core members 28. In one or more arrangements, telescoping members 30 may be sized to fit within hollow center 38 of core members 28 in relatively close and tight tolerances such that telescoping members 30 only move along a length of core members 28 when a user pushes or pulls telescoping members 30 with sufficient force to overcome the force of friction between telescoping members 30 and core members 28. In one or more arrangements, as examples, telescoping members 30 are sized such that they are able to fit inside hollow center 38 of core members 28 such that telescoping members 30 are not held within close and tight tolerances, and such that telescoping members 30 may slide relatively freely along a length of core members 28 with little force required to cause such sliding.

In one or more arrangements, as examples, when viewed from top side 18 of system 10, telescoping members 30 are generally rectangular in shape, with the opposing sides 52 extending in approximate parallel planar spaced relation to one another and in approximate perpendicular planar relation to ends 54. In one or more arrangements, as examples, when viewed from either forward end 12 or rearward end 14 of system 10, telescoping members 30 are generally rectangular in shape, with opposing top and bottom surfaces 50 extending in approximate parallel planar spaced relation to one another and in approximate perpendicular planar relation to ends 54. In one or more arrangements, as examples, when viewed from either side 16 of system 10, telescoping members 30 are generally square in shape, with opposing top and bottom surfaces 50 extending in approximate parallel planar spaced relation to one another and in approximate perpendicular planar relation to opposing sides 52.

In one or more arrangements, as examples, telescoping members 30 include end caps 56. End caps 56 are formed of any suitable size, shape, and design and are configured to be placed on ends 54 to prevent material from getting into the hollow center 58 of telescoping members 30. In one or more arrangements, as examples, end caps 56 are formed primarily of a plastic material, however end caps 56 may be formed of any other non-metallic material such as a fiberglass material, a wooden material, or any other non-metallic material and/or composite thereof. In one or more arrangements, as examples, end caps 56 are also configured to help prevent scratching or other damage to the truck bed when system 10 is used in a truck bed. That is, end caps 56 are configured to be formed of a material which does not scratch or damage a truck bed when the end caps 56 come in contact with, and move across a portion of, the truck bed.

In one or more arrangements, as examples, telescoping members 30 include a hollow center 58. Hollow center 58 is formed of any suitable size, shape, and design and is configured to allow for fasteners 42, stabilizer pins 62, and any other components to extend through telescoping members 30. In one or more arrangements, as examples, hollow center 58 is a generally square opening in telescoping members 30 which extends from one end 54 to the other end 54 of telescoping members 30. In one or more arrangements, as examples, hollow center 58 is sized such that end caps 56 may be at least partially inserted into the hollow center 58 at each of the ends 54 of telescoping members 30, and end caps 56 are configured to be held within close and tight tolerances at ends 54.

In one or more arrangements, as examples, hollow center 58 may be formed in the manufacturing process of the telescoping members 30, such as when telescoping members 30 are manufactured using a forming or bending process. In one or more alternative arrangements, as examples, where telescoping members 30 are manufactured using a machining process, hollow center 58 may be formed by the removal of material in the center of telescoping members 30. In one or more alternative arrangements, as examples, where telescoping members 30 are manufactured using an additive manufacturing process, hollow center 58 may be created due to the lack of added material in the center of telescoping members 30.

In one or more arrangements, as examples, telescoping members 30 include openings 60. Openings 60 are formed of any suitable size, shape, and design and are configured to allow for pins, fasteners, dowels, or other features to be inserted into and through telescoping members 30 for various purposes. In one or more arrangements, as examples, openings 60 are circular perforations which are present throughout the length of telescoping members 30 and openings 60 are approximately equally spaced from one another. Said another way, in one or more arrangements as examples, a first opening 60 is present near end 54 of telescoping members 30, a second opening 60 is present near the other end 54 of telescoping members 30, and additional openings 60 are present in between the first opening 60 and the second opening 60 and such additional openings 60 are approximately equally spaced apart from one another.

However, system 10 and telescoping members 30 are not so limited. In one or more alternative arrangements, as examples, telescoping members 30 may not have any openings 60. In further alternative arrangements, as examples, telescoping members 30 may have any number of openings 60 and such openings 60 may be positioned and spaced in any manner.

In one or more arrangements, openings 60 are configured to receive and hold various different pins, fasteners, dowels, or other features in order to secure system 10 or perform other functions necessary for using system 10. In one or more arrangements, as examples, openings 60 may be configured to receive one or more eye bolts 44. Eye bolts 44 are formed of any suitable size, shape, and design and are configured to help properly secure the material being hauled using system 10 to system 10. In one or more arrangements, as examples, openings 60 may be configured to receive one or more dowels 46. Dowels 46 are formed of any suitable size, shape, and design and are configured to help prevent the material being hauled using system 10 from sliding past predetermined parameters, either from side-to-side or forward and backwards relative to the truck bed.

In one or more arrangements, as examples, openings 60 are configured to receive stabilizer pins 62. Stabilizer pins 62 are formed of any suitable size, shape, and design and are configured to be inserted through openings 60 and contact an exterior portion of the truck bed in order to stabilize system 10 when in use. That is, in one or more arrangements as examples, stabilizer pins 62 are configured to contact either an exterior or interior portion of the truck bed that system 10 is being used on in order to prevent system 10 from sliding relative to the truck bed. In one or more arrangements, as examples, stabilizer pins 62 may be used when system 10 is intended to effectively extend the width of the truck bed. In these arrangements, as examples, telescoping members 30 are positioned such that they extend outward past the exterior sides of the truck bed and the stabilizer pins 62 are placed through openings 60 such that they contact either the exterior or interior sides of the truck bed, on each side of the truck bed, such that system 10 is not able to slide relative to the truck bed due to stabilizer pins 62.

While extension members 22 and its various components have been described with reference to the arrangements shown, as examples, it will be understood by those skilled in the art that any other configuration of extension members 22 and its various components may be used in order to help effectively extend the working length and/or width of a truck bed.

In the arrangements shown, as examples, system 10 includes two extension members 22, one at the forward end 12 and one at the rearward end 14 of system 10. In one or more arrangements, as examples, the two extension members 22 are connected by connection members 24.

### Connection Members 24:

In one or more arrangements, as examples, system 10 includes connection members 24. Connection members 24 are formed of any suitable size, shape, and design and are configured to connect extension members 22 and provide support to system 10. In one or more arrangements, as examples, connection members 24 have opposing top and bottom surfaces 66, opposing sides 68, and opposing ends 70 with end caps 72. In one or more arrangements, as examples, connection members 24 include a hollow center 74, openings 76, U-bolts 78, and pins 80. In one or more arrangements, connection members 24 may also include eye bolts 44 and/or dowels 46.

In one or more arrangements, as examples, connection members 24 are formed of a single, unitary member that is formed in a manufacturing process such as machining, extrusion, forming, bending, additive manufacturing, or the like to form a unitary and monolithic member. Alternatively, connection members 24 may be formed of multiple pieces that are connected or assembled to one another through welding, however any other means of connecting or assembling the multiple pieces may be used, including screwing, bolting, friction fitting, or the like. In one or more arrangements, as examples, connection members 24 are formed primarily of a metallic material such as steel, aluminum, chromium, or any other metallic material, alloy, and/or composite thereof. Alternatively, connection members 24 may be formed of a non-metallic material such as a plastic material, a fiberglass material, or any other non-metallic material and/or composite thereof.

In one or more arrangements, as examples, connection members 24 are steel square tubes. However, connection members 24 are not so limited and, in one or more arrangements as examples, connection members 24 may be any other shape, design, or configuration of elongated material. In one or more arrangements, as examples, when viewed from top side 18 of system 10, connection members 24 are generally rectangular in shape, with the opposing sides 68 extending in approximate parallel planar spaced relation to one another and in approximate perpendicular planar relation to each opposing ends 70. In one or more arrangements, as examples, when viewed from either forward end 12 or rearward end 14 of system 10, connection members 24 are generally square in shape, with opposing top and bottom surfaces 66 extending in approximate parallel planar spaced relation to one another and in approximate perpendicular planar relation to opposing sides 68. In one or more arrangements, as examples, when viewed from either side 16 of system 10, connection members 24 are generally rectangular in shape, with opposing top and bottom surfaces 66 extending in approximate parallel planar spaced relation to one another and in approximate perpendicular planar relation to opposing ends 70.

In one or more arrangements, as examples, connection members 24 include end caps 72. End caps 72 are formed of any suitable size, shape, and design and are configured to be placed on at least one of the opposing ends 70 to prevent material from getting into the hollow center 74 of connection members 24. In one or more arrangements, as examples, end caps 72 are formed primarily of a plastic material, however end caps 72 may be formed of any other non-metallic material such as a fiberglass material, a wooden material, or any other non-metallic material and/or composite thereof.

In one or more arrangements, as examples, connection members 24 include a hollow center 74. Hollow center 74 is formed of any suitable size, shape, and design and is configured to allow for pins 80, and any other components to extend through connection members 24. In one or more arrangements, as examples, hollow center 74 is a generally square opening in connection members 24 which extends from one opposing end 70 to the other opposing end 70 of connection members 24. In one or more arrangements, as examples, hollow center 74 is sized such that end caps 72 may be at least partially inserted into the hollow center 74 at each of the opposing ends 70 of connection members 24, and end caps 72 are configured to be held within close and tight tolerances at each of the opposing ends 70.

In one or more arrangements, as examples, hollow center 74 may be formed in the manufacturing process of the connection members 24, such as when connection members 24 are manufactured using a forming or bending process. In one or more alternative arrangements, as examples, where connection members 24 are manufactured using a machining process, hollow center 74 may be formed by the removal of material in the center of connection members 24. In one or more alternative arrangements, as examples, where connection members 24 are manufactured using an additive manufacturing process, hollow center 74 may be created due to the lack of added material in the center of connection members 24.

In one or more arrangements, as examples, connection members 24 include openings 76. Openings 76 are formed of any suitable size, shape, and design and are configured to allow for pins, fasteners, dowels, or other features to be inserted into and through connection members 24 for various purposes. In one or more arrangements, as examples, openings 76 are circular perforations which are present throughout the length of connection members 24 and approximately equally spaced from one another. Said another way, in one or more arrangements as examples, a first opening 76 is present near one opposing end 70 of connection members 24, a second opening 76 is present near the other opposing end 70 of connection members 24, and additional openings 76 are present in between the first opening 76 and the second opening 76 and such additional openings 76 are approximately equally spaced apart from one another.

However, system 10 and connection members 24 are not so limited. In one or more alternative arrangements, as examples, connection members 24 may not have any openings 76. In further alternative arrangements, as examples, connection members 24 may have any number of openings 76 and such openings 76 may be positioned and spaced in any manner.

In one or more arrangements, openings 76 are configured to receive and hold various different pins, fasteners, dowels, or other features in order to secure system 10 or perform other functions necessary for using system 10. In one or more arrangements, as examples, openings 76 may be configured to receive one or more eye bolts 44. Eye bolts 44 are formed of any suitable size, shape, and design and are configured to help properly secure the material being hauled using system 10 to system 10. In one or more arrangements, as examples, openings 76 may be configured to receive one or more dowels 46. Dowels 46 are formed of any suitable size, shape, and design and are configured to help prevent the material being hauled using system 10 from sliding past predetermined parameters, either from side-to-side or from front-to-back relative to the truck bed.

In one or more arrangements, as examples, openings 76 are configured to receive pins 80. Pins 80 are formed of any suitable size, shape, and design and are configured to be inserted through openings 76 and contact an exterior or interior portion of the truck bed in order to stabilize system 10 when in use. In one or more arrangements, as examples, pins 80 are configured to contact an exterior or interior portion of the truck bed that system 10 is being used on in order to prevent system 10 from forward relative to the truck bed. In one or more arrangements, as examples, pins 80 are used when system 10 is intended to effectively extend the length of the truck bed. In these arrangements, as examples, connection members 24 are positioned such that they extend outward past the tailgate (back end) of the truck bed and the pins 80 are placed through openings 76 such that they contact the exterior or interior side of the tailgate of the truck bed such that system 10 is not able to slide relative to the truck bed due to pins 80.

In one or more arrangements, as examples, pins 80 may also be used to control the incline at which system 10 is angled out of the truck bed. That is, in one or more arrangements, the placement of pins 80 along connection members 24 determines the angle at which system 10 is angled out of the truck bed. In one or more arrangements, the truck upon which system 10 is installed may be used to tow something as well, such as a boat or a trailer. In such situations, it may be beneficial for system 10 to be angled at a greater incline upwards so as to not stick out of the truck bed so far that it contacts the item being towed.

In one or more arrangements, as examples, connection members 24 may include U-bolts 78. U-bolts 78 are formed of any suitable size, shape, and design and are configured to facilitate secure connection between connection members 24 and extension members 22. In one or more arrangements, as examples, there are four U-bolts 78, with one U-bolt 78 positioned near each of the opposing ends 70 of connection members 24, where connection members 24 meet extension members 22. However, any other number of U-bolts 78 may be used depending on the number and positioning of connection members 24 and/or extension members 22.

In one or more arrangements, as examples, connection members 24 overlap with an extension member 22 at each opposing end 70 of connection members 24. Where connection members 24 and an extension member 22 overlap, the connection member 24 and extension member 22 are connected to one another via one or more U-bolts 78. In one or more arrangements, as examples, the U-bolts 78 form a U-shaped bolt, with threaded ends and a curved middle section which joins the threaded ends.

In one or more arrangements, as examples, one threaded end of a U-bolt 78 extends through an opening 76 of connection members 24 on one side of the extension member 22, and the other threaded end of the U-bolt 78 extends through an opening 76 of connection members 24 on the other side of the extension member 22. In this manner, the U-bolt 78 has a threaded end on each side of extension member 22 and the curved middle section extends upward from the threaded ends to partially surround extension member 22. In this arrangement as one example, extension member 22 is surrounded on all four sides: one side by connection member 24, one side by each of the threaded ends of the U-bolt 78, and one side by the curved middle section of the U-bolt 78. Once extension member 22 is surrounded on all four sides, nuts are threaded onto the threaded ends of U-bolt 78. As the nuts are threaded onto the threaded ends of U-bolts 78, the U-bolt 78 is pulled downward and contacts extension member 22, which in turn is pulled downward and contacts connection member 24. Once these contacts/connections are secure and the nuts are tight, connection members 24 and extension members 22 are securely connected to one another.

### Alternative Connection Method:

In one or more alternative arrangements, as examples, connection members 24 may be connected to extension members 22 via brackets 90. Brackets 90 are made of any suitable size, shape, and design and are configured to operably connect extension members 22 to connection members 24. In the arrangement shown, as one example, brackets 90 are brackets which allow members which cross perpendicularly to be protected. In one or more arrangements, as examples, brackets 90 may be post cap/base brackets. In one or more arrangements, as examples, brackets 90 may be shaped such that they allow one member to pass between sidewalls on the top side of brackets 90 in a first direction and a second member to pass through sidewalls on the bottom side of brackets 90 in a second direction which is at an angle between 5 and 175 degrees with respect to the first direction.

In one or more alternative arrangements, shown as examples, brackets 90 allow extension members 22 to pass through sidewalls 92 on the upper side of brackets 90 in a first direction. In one or more alternative arrangements, shown as examples, brackets 90 allow connection members 24 to pass through sidewalls 92 on the lower side of brackets 90 in a second direction which is approximately perpendicular to the first direction. In one or more alternative arrangements, as examples, brackets 90 include openings 94 which are configured to align with openings 40 of core members 28 of extension members 22 and/or openings 76 of connection members 24.

In one or more alternative arrangements, as examples, brackets 90 are operably connected to extension members 22 and connection members 24 by placing a fastener 96 through the openings 94 of brackets 90 as well as the openings 40 of core members 28 and openings 76 of connection members 24, thereby operably securing brackets 90 to extension members 22 and connection members 24. In one or more arrangements, as examples, fastener 96 may be a screw, nut and bolt, pin, or any other type of fastener or member configured to connect brackets 90 to extension members 22 and connection members 24.

While connection members 24 and their various components have been primarily with reference to the arrangement shown, as one example, it will be understood by those skilled in the art that any other configuration of connection members 24 and their various components may be used in order to connect multiple extension members 22 and provide support to system 10.

### First Set of Straps 82:

In one or more arrangements, as examples, system 10 includes a first set of straps 82. First set of straps 82 are formed of any suitable size, shape, and design and are configured to secure system 10 to the truck bed. In one or more arrangements, as examples, first set of straps 82 are ratchet straps, however any other means of securing system 10 to the truck bed can be used including cam buckle straps, bungee cords, lashing straps, or any other type of strap, tie down, or other mechanism for securing system 10 to the truck bed.

In one or more arrangements, as examples, one end of the first set of straps 82 is configured to connect to the hitch receiver of the truck that system 10 is installed onto. In one or more arrangements, as examples, the other end of the first set of straps 82 is configured to connect to an opening 76 of connection members 24. With the first set of straps 82 secured to the hitch receiver and the connection members 24, the first set of straps 82 are tightened such that system 10 is held tightly in place by the first set of straps 82. In this way, first set of straps 82 prevent system 10 from bouncing up and down and from sliding side to side or from front-to-back, when system 10 is being used.

In one or more arrangements, as examples, there are two straps in the first set of straps 82. However, first set of straps 82 is not so limited and, in one or more alternative arrangements as examples, first set of straps 82 may have only one strap, or may have three straps, four straps, or any other number of straps sufficient to secure system 10 to the truck bed.

### Second Set of Straps 84:

In one or more arrangements, as examples, system 10 includes a second set of straps 84. Second set of straps 84 are formed of any suitable size, shape, and design and are configured to secure material being hauled to system 10. In one or more arrangements, as examples, second set of straps 84 are ratchet straps, however any other means of securing system 10 to the truck bed can be used including cam buckle straps, bungee cords, lashing straps, or any other type of strap, tie down, or other mechanism for securing material to system 10.

In one or more arrangements, as examples, one end of the second set of straps 84 is configured to connect to an extension member 22 on one side of the material being hauled and the second end of the second set of straps 84 is configured to connect to the extension member 22 on the other side of the material being hauled. With the second set of straps 84 secured on both sides of the material being hauled, the second set of straps 82 are tightened such that material being hauled is tightly held against system 10. In this way, second set of straps 84 prevent the material being hauled from bouncing up and down and from sliding side to side or from front-to-back when system 10 is being used.

In one or more arrangements, as examples, there are two straps in the second set of straps 84, with one strap connected to a first extension member 22 and a second strap connected to a second extension member 22. However, second set of straps 84 is not so limited. In one or more arrangements second set of straps 84 may be connected to the material being hauled, any extension member 22, any connection member 24, or any other part of system 10 or the truck that system 10 is installed in, and the second set of straps 84 may be connected in any manner that secures the material being hauled. Additionally, in one or more alternative arrangements as examples, second set of straps 84 may have only one strap, or may have three straps, four straps, or any other number of straps sufficient to secure material being hauled to system 10.

### Assembly and Use:

### Assembling Extension Members 22:

In one or more arrangements, as examples, system 10 is configured to effectively extend the working length and/or width of a truck bed. In one or more arrangements, as examples, extension members 22 of system 10 are assembled by placing an opposing end 54 of a telescoping member 30 adjacent an opposing end 36 of a core member 28, aligning the telescoping member 30 with the hollow center 38 of the core member 28, and inserting the telescoping member 30 into the hollow center 38 of core members 28. In one or more arrangements, as examples, the telescoping member 30 is inserted into the hollow center 38 of the core member 28 a distance that allows at least a portion of the telescoping member 30 to extend outward from the opposing end 36 of the core member 28. In one or more arrangements, as examples, the openings 60 of the telescoping member 30 are aligned with the openings 40 of the core member 28 such that one or more fasteners 42 may be placed through openings 40 and openings 60 in order to secure the telescoping member 30 to the core member 28.

Next, in one or more arrangements, as examples, the user places an opposing end 54 of a second telescoping member 30 adjacent the other opposing end 36 of the core member 28, and the user aligns the telescoping member 30 with the hollow center 38 of the core member 28, and finally the user inserts the telescoping member 30 into the hollow center 38 of core members 28, with at least a portion of the telescoping member 30 extending outward from the opposing end 36 of the core member 28. Finally, the user aligns the openings 60 of the telescoping member 30 with the openings 40 of the core member 28 and one or more fasteners 42 are placed through openings 40 and openings 60 in order to secure the telescoping member 30 to the core member 28. In one or more arrangements, as examples, these steps are repeated a second time to form a second extension member 22. In various alternative arrangements, as examples, these steps may be repeated any number of times to produce the desired number of extension members 22.

Connecting Extension Members 22 and Connection Members 24 using U-Bolts 78:

In one or more arrangements, as examples, once the extension members 22 are formed, connection members 24 will be used to connect the extension members 22. In one or more arrangements, as examples, an opposing end 70 of a connection member 24 is placed such that connection member 24 is overlapping with an extension member 22. A U-bolt 78 is then placed over the extension member 22, with a first threaded end of the U-bolt 78 extending through an opening 76 of the connection member 24 and a second threaded end of the U-bolt 78 extending through another opening 76 of the connection member 24. In this manner, the curved middle section of the U-bolt 78 is positioned above the top surface 32 of the extension member 22, the two threaded ends of the U-bolt 78 are positioned on either opposing side 34 of extension member 22, and the connection member 24 is positioned below the extension member 22. With extension member 22 surrounded in this manner by the U-bolt 78 and connection member 24, nuts are then threaded onto the threaded ends of U-bolt 78, which pull the U-bolt 78, extension member 22, and connection member 24 into close and tight contact with one another, thereby securing the extension member 22 to the connection member 24. In one or more arrangements, as examples, this process is then repeated a second time to connect the other end 70 of the connection member 24 to the second extension member 22. In one or more arrangements, as examples, this process is then repeated with a second connection member 24. In various alternative arrangements, as examples, this process may be repeated any number of times to connect the desired numbers of connection members 24 to the extension members 22.

Connecting Extension Members 22 and Connection Members 24 using Brackets 90:

In one or more alternative arrangements, as examples, the various extension members 22 may be connected to one another and to connection members 24 via bracket 90. In one or more alternative arrangements, as examples, a bracket 90 is placed on top of a connection member 24 near an opposing end 70 of the connection member 24. In one or more arrangements, as examples, when bracket 90 is placed on top of connection member 24, a sidewall 92 is positioned on each opposing side 68 of connection member 24. In one or more alternative arrangements, as examples, bracket 90 is positioned such that openings 94 in the sidewalls 92 of bracket 90 align with openings 76 of connection member 24. Once properly positioned, a fastener 96 is inserted through openings 94 and openings 76 and properly secured, such that the bracket 90 is operably connected to the connection member 24. This process is then repeated at the other opposing end 70 of connection member 24. In one or more alternative arrangements, as examples, an extension member 22 is then placed on top of the bracket 90 at an opposing end 70 of connection member 24. In the one or more alternative arrangements, as examples, the extension member 22 is placed such that a sidewall 92 of bracket 90 is positioned on each opposing side 34 of core member 28 of extension member 22. In one or more alternative arrangements, as examples, openings 94 in the sidewalls 92 align with openings 40 of core members 28. Once properly positioned, a fastener 96 is inserted through openings 94 and openings 40 and properly secured, such that the bracket 90 is operably connected to the extension member 22. This process is then repeated with a second extension member 22 and the bracket 90 at the other opposing end 70 of connection member 22.

In various alternative arrangements, as examples, this process may be repeated any number of times in order to connect the desired number of connection members 24 to the desired number of extension members 22.

### Installing System 10 on a Truck Bed to Extend the Length of the Truck Bed:

Once the desired number of connection members 24 are properly connected to the desired number of extension members 22, system 10 is ready to be installed in a truck bed. In one or more arrangements, as examples, the telescoping members 30 are to be adjusted to correspond with the width of the truck bed system 10 is being installed in. In one or more arrangements, as examples, telescoping members 30 may be adjusted by removing or loosening fasteners 42 (if they are already installed), sliding the telescoping members 30 to the desired position, and tightening or replacing the fasteners 42 through openings 40 of core members 28 and properly securing then in order to lock telescoping members 30 in place. In one or more arrangements, as examples, telescoping members 30 may be extended any length such that the extension members 22 may extend to any length. In one or more arrangements, as examples, telescoping members 30 may be extended such that the extension members 22 may extend a length between 48 inches and 76 inches, however telescoping members 30 and extension members 22 are not so limited and may be designed such that extension members 22 may extend to any length.

Truck beds typically include sidewalls and a tailgate at the end of the truck bed. The truck beds also typically include a protrusion which extends inward at the top of the sidewalls. In one or more arrangements, as examples, system 10 is lifted and placed on top of the truck bed, with one extension member 22 resting on top of each of the sidewalls of the truck bed and the other extension member 22 located past the tailgate of the truck bed. In one or more arrangements, as examples, system 10 is tilted such that one opposing end 54 of a telescoping member 30 is positioned under the protrusion near the top of one of the sidewalls of the truck bed. System 10 is then tilted again such that another opposing end 54 of a telescoping member 30 is positioned under the protrusion near the top of the other sidewall of the truck bed. The user then pulls system 10 such that the extension member 22 is approximately perpendicular to the sidewalls of the truck bed and, in this position, the extension member 22 is held between the sidewalls of the truck bed and underneath the protrusions near the top of each sidewall. In this position, the extension member 22 is securely attached to the truck bed and, due to the protrusion at the top of each sidewall, extension member 22 is prevented from moving upward.

In this position, the connection members 24 are tilted upwards and rest on top of the tailgate of the truck bed. In this position, the other extension member 22 is still located past the tailgate and end of the truck bed and angled upward from the first extension member 22 connected to the truck bed. The user can then place pins 80 through openings 76 of connection members 24 in order to prevent system 10 from sliding forward and to set the incline of system 10. At this point, a first end of the first set of straps 82 are connected to the hitch receiver of the truck and a second end of the first set of straps 82 are connected to the extension member 22 located past the tailgate and end of the truck bed. The first set of straps 82 are then tightened such that the extension member 22 located past the tailgate is pulled down and the connection members 24 are pulled into tight contact with the top of the tailgate of the truck. When the first set of straps 82 are properly tightened, system 10 is prevented from moving upward and rearward due to the first set of straps 82, and system 10 is also prevented from moving downward due to the tailgate.

With the first extension member 22 positioned under the protrusions on each of the sidewalls of the truck bed, the pins 80 placed through openings 76 of connection members 24, and the first set of straps 82 tightly connecting the second extension member 22 to the hitch receiver of the truck, system 10 is securely connected to the truck bed. At this point, material can be placed into the truck bed and onto system 10. System 10 causes such material to angle upward as it extends from the front of the truck bed to the back of the truck bed due to the material resting on system 10 which is angled upward as well. This angling upward of the material allows for the truck bed to be used to haul longer objects. In other words, because of the angle created by system 10, system 10 effectively extends the working length of the truck bed. The user can then secure the material being hauled to system 10 using the second set of straps 84 and the material is ready to be hauled once strapped down.

### Installing System 10 on a Truck Bed to Extend the Width of the Truck Bed:

In order to extend the effective width of the truck bed using system 10, system 10 is installed on a truck bed in the following manner. In one or more arrangements, as examples, the telescoping members 30 of each extension member 22 is extended outward (as described herein) to correspond with the width of the material being hauled. In one or more arrangements, as examples, telescoping members 30 may be extended any length such that the extension members 22 may extend to any length. In one or more arrangements, as examples, telescoping members 30 may be extended such that the extension members 22 may extend a length between 48 inches and 76 inches, however telescoping members 30 and extension members 22 are not so limited and may be designed such that extension members 22 may extend to any length.

System 10 may then be placed on top of the sidewalls and tailgate of the truck bed, with the first extension member 22 extending outward past each of the sidewalls of the truck bed, the connection members 24 extending a length past the tailgate, and the second extension member 22 positioned past the tailgate of the truck bed. In this position, a third set of straps (which are similar or identical to the first set of straps 82) are placed such that a first end of the third set of straps connects to a hook near the front end of the truck bed and a second end of the third set of straps connects to the first extension member 22. Once the third set of straps is properly connected to a hook near the front end of the truck bed and to the first extension member 22, the third set of straps are tightened so the first extension member 22 is held tightly by the third set of straps.

Next, the first set of straps 82 are connected to the hitch receiver and the second extension member 22 as has been described herein. Pins 80 are then placed through openings 76 of connection member 24 such that they contact the outside of the tailgate of the truck bed, thereby preventing system 10 from sliding forward. The first set of straps 82 are then tightened such that the second extension member 22 and the connection members 24 are pulled downward and into close contact with the tailgate of the truck bed. At this point, system 10 is securely attached to the truck bed.

With system 10 securely attached to the truck bed and if desired, eye bolts 44, dowels 46, and/or any other type of fastener, member, or feature may be inserted through the openings 60 of telescoping members 30 in order to help prevent the material being hauled from sliding side to side. The material to be hauled can then be placed on top of system 10 and secured to system 10 using the second set of straps 84 as has been described previously herein. In this way, system 10 can be used to effectively extend the working width of the truck bed.

From the above discussion it will be appreciated that the system 10 presented herein improves upon the state of the art. Specifically, in one or more arrangements, a truck bed extension system 10 is presented which: improves upon the state of the art; extends the effective size of the truck bed; is safe to install; is quick to install; is easy to install; is safe to use while driving; is able to comply with road width travel restrictions; is relatively easy to build; can be built relatively quickly and efficiently; is easy to operate; is relatively cost friendly to manufacture; is relatively easy to transport; is aesthetically appealing; is robust; is not easily susceptible to wear and tear; has a long useful life; is efficient to use and operate; allows for temporary use and can be quickly and easily installed and removed without defacing the truck bed; can be used short term and can be quickly and easily be installed and removed without defacing the truck bed; allows for use with existing or new truck bed covers that require no removal or modifications; provides two cross bars for securing the load in various different configurations; can fit in the truck bed when not in use.

What is claimed:

1. A truck bed extension system for use in connection with a truck having a truck bed comprising:
a plurality of extension members;
the plurality of extension members having core members;
the plurality of extension members having telescoping members;
wherein the telescoping members are configured to extend outward from the core members;
a plurality of connection members;
wherein the plurality of connection members are configured to connect to the plurality of extension members;
wherein the plurality of extension members are configured to engage a portion of the truck bed;
wherein the truck bed extension system is configured to extend outward from the truck bed;
wherein the truck bed extension system is configured to allow the truck to haul material or objects that are larger than the truck bed.

2. The truck bed extension system of claim 1 wherein the core members are tubes having opposing top and bottom surfaces, opposing left and right sides, and opposing ends.

3. The truck bed extension system of claim 1 wherein the telescoping members are tubes having ends.

4. The truck bed extension system of claim 1 wherein the plurality of connection members are tubes having opposing top and bottom surfaces, opposing left and right sides, and the opposing ends.

5. The truck bed extension system of claim 1 wherein the plurality of connection members include at least one fastener and the at least one fastener facilitates connection of the plurality of connection members to the plurality of extension members.

6. The truck bed extension system of claim 1 further comprising:
at least one first strap;
wherein the at least one first strap is configured to secure the truck bed extension system to the truck;
at least one second strap;
wherein the at least one second strap is configured to connect the material or objects hauled by the truck to the truck bed extension system.

7. The truck bed extension system of claim 1 wherein the plurality of extension members may extend between a length of 48 inches and a length of 80 inches.

8. A truck bed extension system for use in connection with a truck having a truck bed comprising:
a first extension member;
the first extension member having a core member;
the first extension member having a telescoping member;
wherein the telescoping member is configured to extend outward from the core member;
a second extension member;
the second extension member having a core member;
the second extension member having a telescoping member;
wherein the telescoping member is configured to extend outward from the core member;
a first connection member;
the first connection member having a first end and a second end;
a second connection member;
the second connection member having a first end and a second end;
wherein the first end of the first connection member is configured to connect to the first extension member and the second end of the first connection member is configured to connect to the second extension member;
wherein the first end of the second connection member is configured to connect to the first extension member and the second end of the second connection member is configured to connect to the second extension member;
wherein the first extension member is configured to engage a portion of the truck bed;
wherein the truck bed extension system is configured to extend outward from the truck bed;
wherein the truck bed extension system is configured to allow the truck to haul material or objects that are larger than the truck bed.

9. The truck bed extension system of claim 8 wherein the core member of the first extension member is a tube having opposing top and bottom surfaces, opposing left and right sides, and opposing ends and wherein the core member of the second extension member is a tube having opposing top and bottom surfaces, opposing left and right sides, and opposing ends.

10. The truck bed extension system of claim 8 wherein the first telescoping member is a tube having ends and wherein the second telescoping member is a tube having ends.

11. The truck bed extension system of claim 8 wherein the first connection member is a tube having opposing top and bottom surfaces, opposing left and right sides, and opposing ends and wherein the second connection member is a tube having opposing top and bottom surfaces, opposing left and right sides, and opposing ends.

12. The truck bed extension system of claim 8,
wherein the first connection member includes at least one fastener at each opposing end of the first connection member,
wherein the at least one fastener at each opposing end of the first connection member facilitates connection of each opposing end of the first connection member to the first extension member and the second extension member;
wherein the second connection member includes at least one fastener at each opposing end of the second connection member; and
wherein the at least one fastener at each opposing end of the second connection member facilitates connection of each opposing end of the second connection member to the first extension member and the second extension member.

13. The truck bed extension system of claim 8 further comprising:
the first connection member and the second connection member having a first set of straps;
wherein the first set of straps are configured to secure the truck bed extension system to the truck;
a second set of straps;
wherein the second set of straps are configured to connect the material or objects hauled by the truck to the truck bed extension system.

14. The truck bed extension system of claim 8 wherein the first extension member and the second extension member may extend between a length of 48 inches and a length of 80 inches.

15. A method of installing a truck bed extension system for use in connection with a truck having a truck bed, the method comprising:
providing a truck bed extension system having a plurality of extension members and a plurality of connection members;
adjusting the length of the plurality of extension members to correspond to a width of the truck bed;
placing a first opposing end of a first extension member of the plurality of extension members into the truck bed and placing the first opposing end of the first extension member under a protrusion of a first sidewall of the truck bed;
placing a second opposing end of the first extension member of the plurality of extension members into the truck bed and placing the second opposing end of the first extension member under a protrusion of a second sidewall of the truck bed;
squaring the first extension member with the first sidewall and the second sidewall of the truck bed;
adjusting the truck bed extension system to a desired position;
inserting stabilizer pins through openings in the connection members;
wherein said stabilizer pins are configured to engage an outer wall of the truck bed to prevent the truck bed extension system from moving forward while the truck is traveling;
connecting a first set of straps to the plurality of connection members and to the truck;
wherein the first set of straps are configured to prevent the truck bed extension system from moving vertically while the truck is traveling;
placing material or objects to be hauled such that at least a portion of the material or objects being hauled is in contact with the truck bed extension system;
connecting a second set of straps to the material or objects and to one of the truck bed extension system or the truck;
wherein the second set of straps are configured to prevent the material or objects from shifting while the truck is traveling.
